(19) United States
(12) Patent Application Publication
(10) Pub. No.: US 2010/0072334 A1
(43) Pub. Date: Mar. 25, 2010

(54) Holder for Electronic Device with Support

(75) Inventors: Brian E. Le Gette, Baltimore, MD (US); David Reeb, Sykesville, MD (US)

Correspondence Address: EDELL, SHAPIRO & FINNAN, LLC, 1901 RESEARCH BOULEVARD, SUITE 400, ROCKVILLE, MD, 20850, US

(73) Assignee: Zero Chroma, LLC, Sykesville, MD (US)

(21) Appl. No.: 12/556,182

(22) Filed: Sep. 9, 2009

Related U.S. Application Data
(60) Provisional application No. 61/191,454, filed on Sep. 9, 2008.

(51) Int. Cl. F16M 11/04; G10K 11/20; B23P 11/00

(52) U.S. Cl. 248/176.3; 29/428; 181/211

(57) ABSTRACT

A protective holder for the iPhone®, iPod Touch™, electronic books, electronic tablet computers and other portable devices having a frontal LCD, OLED, touch screen, or other display that employs a form-fitting backplate with corner frames for cradling the device while leaving the entire frontal aspect unobstructed is disclosed. The holder may include a series of contoured side grippers on each side of the backplate for clamping the device in place without obstructing the LCD screen (or access to it for cleaning or otherwise). The holder may include a fully-adjustable kickstand for upright hands-free viewing of the device at several landscape and portrait angles and the holder may also include a built-in moveable directional sound reflector and noise shield improves audio performance, and a detachable belt clip allows belt wearing. The holder has an extreme slimline folded profile to facilitate pocket insertion, minimize bulk and create an eye-catching aesthetic.

### CROSS-REFERENCE TO RELATED APPLICATION

This application claims priority to and the benefit of U.S. Provisional Patent Application No. 61/191,454, filed Sep. 9, 2008, entitled “Versatile Hard-Shell Holder for Mobile Phones, PDAs and Portable Music/Video Players,” the entire disclosure of which is incorporated herein by reference in its entirety.

### BACKGROUND OF THE INVENTION

The present invention relates to cases or holders for cell phones, personal digital assistants (PDAs), portable video/music players, electronic books, electronic tablets and other handheld devices, as well as the devices themselves. The present invention also relates to a versatile protective holder that can allow placement on any surface for hands-free viewing, with full adjustment of viewing angle in landscape and/or portrait orientations; directional sound reflecting and baffling; easier cleaning and viewing of the device's screen; easier grasping by the user; wearing of the device using a belt clip or waist band; as well as attachment to an automobile, bicycle, or other vehicle.

In this new era of digital convergence, portable devices are increasingly being used for multiple tasks ranging from telephony to computing to video and audio entertainment. For example, Apple's iPhone® mobile digital device is a fully functional cell phone, image browser, video library and video-on-demand terminal. Apple also has a variety of iPod® portable video/music players and has recently introduced the new iPod Touch® mobile digital device which is the first-ever Wi-Fi iPod® that can download and play video in realtime on a 3.5-inch widescreen display. While some users prefer to carry such handheld devices in a shirt pocket, handbag or pants pocket, others prefer to clip the device to their belt. Regardless, there is often a desire to stand the device at an incline when watching video programming or viewing still images. In order to serve all viewing preferences and as well to protect their device, users often purchase protective holders with detachable belt clips and/or viewing stands.

There are a variety of conventional hard-shell and soft-shell holders available for mobile phones, PDAs and portable video/music players, but these have rather limited functionality. Although they generally succeed in protecting the mobile phone/PDA/tablet/portable video/music player, they can detract from its portability, usability and/or aesthetic appearance, and fall short of the needs of the user in many other ways. The framework employed to restrain the PDA/cell phone/portable video/music player can make them unwieldy to slip into a shirt pocket. Moreover, the stand mechanisms currently in use often compel either landscape or portrait viewing, but not both. This limits versatility. None of these other holders attempt to directionally reflect and/or magnify sound from the devices speakers, or directionally block sound from a device's microphone.

For example, the iPhone® and iPod Touch® mobile digital devices are smart terminals that automatically adjust their displays of still images to landscape or portrait viewing mode depending on the orientation of the device. On the other hand, when video is played back, the iPhone® device automatically rotates the display to landscape. While Belkin™ and other manufacturers produce a case for the iPhone® with a transformable belt clip or kickstand for video viewing, the belt clip/kickstand is bulky and prevents insertion into one's pocket. Moreover, the incline of the device cannot be adjusted. This problem becomes acute in certain situation such as on an airplane where placement of the device is limited to a tray over which the user is hunched, and the device is best viewed at a relatively flat incline to properly see the LCD screen. In addition, the case is a clamshell design that clamps over the iPhone® preventing it from being readily removed from the case. Both Scosche™ and Cover Case™ produce a case with a kickstand, however, the kickstand has only one extended position. In the case of Scosche™, the kickstand can be placed in a single extended position that provides for only one angle adjustment which severely limits the usability of the device. Gorilla™ makes a tripod without a protective holder that enables multi-angle viewing but it does not protect the device, nor retract into a flush position disposed within the body of the case.

It would be greatly advantageous to provide a more functional holder for the iPhone®, iPod® line, and other PDAs, cell phones, electronic tablet computers, electronic books and portable video/music players. Such a holder could include one or more of the features of 1) resilient side grippers that clamp around the device to protect it without obscuring the display or controls; 2) all-around symmetric features that allow the device to be inserted in either 180 orientations without compromising usability; 3) an adjustable kickstand or support that allows adjustment of the viewing angle within a broad range, as well as landscape and/or portrait viewing; 4) an extremely low profile to facilitate pocket insertion; 5) a detachable belt clip for wearing; 6) directional sound deflector, 7) minimized screen blockage to enable easy one handed cleaning, 8) an automotive, bicycle or other vehicle attachment, 9) easy to hold finger depressions, 10) slim, low-profile design that does not adds minimal additional bulk, and 11) an eye-catching aesthetic.

### SUMMARY OF THE INVENTION

It is an object of the present invention to provide a more versatile protective case especially suited for Apples' iPhone® or iPod Touch® mobile digital devices, or any other portable device with a frontal LCD screen, organic light-emitting diodes (OLED) screen, touch-viewing screen, or any other type of viewing screen. In one embodiment, the case allows to provide a novel adjustable kickstand or support that allows adjustment of the viewing angle within a broad range, as well as landscape or portrait viewing, and yet folds flush to the holder without added thickness. In one embodiment, the support doubles as a shoulder support when hands-free speaking on a cell phone.

It is another object to provide a protective holder as described above that employs resilient protective side grippers that clamp around the device without obscuring the display or controls at all, and thus making it easier for the user to clean the display surface and other useable areas by wiping it against a shirt using only one hand.

It is another object to provide a protective holder as described above with novel multi-position directional sound reflector and noise baffle to improve speaker and microphone audio performance of the device contained in the protective holder.

It is another object to provide novel finger tip shaped depressions to enable easier grasping by the user.

It is another object to provide a connection on the holder that enables coupling to a belt clip for wearing on the belt or waist band.

It is another object to provide all the foregoing features and yet retain an extremely slim, low profile to facilitate pocket insertion, reduce bulk and an eye-catching aesthetic.

It is another object to provide an automotive, bicycle or other vehicle attachment means.

In accordance with the foregoing objects, one embodiment of a protective holder for the iPhone®, iPod Touch®, other iPods®, and other handheld cell phones and portable video/music players having a frontal LCD, OLED, touch screen or other display includes a form-fitting backplate with corner frames for cradling the device while leaving the entire frontal aspect unobstructed. The holder includes a series of contoured side grippers on each side of the backplate for clamping the device in place without obstructing the LCD screen (or access to it for cleaning or otherwise). The holder also includes a novel and multi-position fully-adjustable kickstand or support for upright hands-free viewing of the device at several angles as well as landscape or portrait viewing, while also serving as a hands-free shoulder cradle for speaking into the phone. In one embodiment, the holder includes a detachable belt clip. The holder has an extreme slimline folded profile to facilitate pocket insertion, minimize bulk and create an eye-catching aesthetic.

In addition, a sound reflector and noise shield/baffle is disclosed which improves the audio performance of a device contained in the protective holder. The noise shield slides outward to create a pocket at the bottom of phone. The pocket shields the device's microphone from surrounding noise, and it channels sound outward from the device's external speaker, bouncing it back towards the face of phone and making the external device's speaker or speakers sound louder from specific locations.

In one embodiment, a holder for a portable device includes a body including a first coupling member and a second coupling member, each of the coupling members extending from the body, the coupling members being configured to couple a portable device to the body; and a support movably coupled to the body, the support being movable between a retracted position and at least two extended positions relative to the body, the at least two extended positions including a first extended position and a second extended position, the support being disposed within the body in its retracted position, the support extending from the body in its extended positions, the support being engageable with a support surface to support the body at least two desired angles relative to the support surface.

In one embodiment, the body has an inner surface, an outer surface, and an opening extending from the inner surface to the outer surface, the support being disposed in the opening when the support is in its retracted position. The body has a thickness defined by the distance between the inner surface and the outer surface and the support has a thickness substantially the same as the thickness of the body when the support is in its retracted position.

In one embodiment, the body includes a positioning mechanism, the positioning mechanism defining a plurality of positions in which the support may be retained. In one embodiment, greater than three positions may be defined by the positioning mechanism. The positioning mechanism includes at least one slot and the support includes at least one pin or other similar engagement member, the at least one pin being slidably engaged with the at least one slot.

In one implementation, the body includes a plurality of corners and each of the first and second coupling members is located proximate to one of the corners. The body includes a third coupling member and a fourth coupling member, each of the third coupling member and the fourth coupling member being located proximate to one of the corners of the body. The body may also include a sound reflector/baffle slidably coupled thereto, the sound reflector being movable between a retracted position and a reflecting/baffling position.

In another implementation, a holder for a portable device includes a body including a first coupling member and a second coupling member, each of the coupling members extending from the body, the coupling members being configured to couple a portable device to the body; and a support movably coupled to the body, with a thickness substantially the same as the thickness of the body, the support being movable between a retracted position and at least two extended positions relative to the body, the support being disposed within the body in its retracted position, the support extending from the body in its extended positions, the support being engageable with a support surface to support the body in at least two desired angles relative to the support surface.

In one embodiment, the holder for a portable device includes a body including a first coupling member and a second coupling member, each of the coupling members extending from the body, the coupling members being configured to couple a portable device to the body; and a sound reflector coupled thereto, the sound reflector being movable between a retracted position and a reflecting position. In one implementation, the sound reflector is made or coated by a material that is more sonically reflective than the material of the body.

In one embodiment, a holder for a portable device includes a front surface, a rear surface and a side wall extending between the front surface and the rear surface includes a mounting portion configured to be coupled to the portable device with the front surface of the portable device exposed, the mounting portion covering at least part of the rear surface of the portable device and portions of the side wall of the portable device; and a support portion movably coupled to the mounting portion, the support portion being disposable in a retracted position and in at least two extended positions relative to the mounting portion, substantially all of the support portion being disposed within the body when the support portion is in its retracted position, and substantially all the support portion extending from the body when the support portion is in its extended position.

In one implementation, the support portion is disposed entirely within the mounting portion when the support portion is in its retracted position. The coverage of the side wall by the mounting portion is discontinuous. The support portion includes a first component having a first end and a second end and a second component having a first end and a second end, the first end of the first component is pivotally coupled to the mounting portion, the second end of the first component is pivotally coupled to the second component, and the first end of the first component is slidably coupled to the mounting portion.

In one implementation, the first component includes a substantially planar portion configured to engage a support surface. The orientation of each of the first component and the second component varies when the support portion moves from its retracted position to its extended position. The angle between the first component and the second component varies when the support portion moves from its retracted position to its extended position.

In another embodiment, a holder for a portable device includes a front surface, a rear surface, a side wall extending between the front surface and the rear surface and a plurality of corners includes a base including a first coupling member and a second coupling member, each of the coupling members extending from the base, the coupling members being configured to extend along the side wall of the portable device, the first coupling member being configured to cover a first corner of the portable device, the second coupling member being configured to cover a second corner of the portable device, each of the coupling members having a length such that the front surface of the portable device is not covered by either of the coupling members when the holder is coupled to the portable device; and a support movably coupled to the base, the support being movable between a retracted position and at least two extended positions relative to the base, the support being engageable with a support surface to support the base and the portable device at desired angles relative to the support surface.

In one implementation, the first corner of the portable device is covered by the first coupling member and the second corner of the portable device is covered by the second coupling member. The portable device includes a third corner and a fourth corner, and the base includes a third coupling member that covers the third corner and a fourth coupling member that covers the fourth corner, each of the third coupling member and the fourth coupling member has a length such that the front surface of the portable device is not covered by either of the third or fourth coupling members when the holder is coupled to the portable device. The support extends from the base in its extended position and is disposed within the base in its retracted position.

In one embodiment, a method of manufacturing a holder for an electronic device is disclosed. The holder includes a body and a support having a first support component and a second support component coupled to the first support component, the support being movable between a retracted position and at least two extended positions relative to the body, the support being disposed within the body in its retracted position and extending from the body in its extended positions, the first support component including a first connector and the second support component including a second connector. The method includes the steps of: forming the body with a first coupling member and a second coupling member, each of the coupling members extending from the body and collectively being configured to couple the body to the electronic device, the body including a notch formed therein and a slot formed therein; coupling the first support component to the body by engaging the first connector with the slot; and coupling the second support component to the body by engaging the second connector with the notch.

In one implementation, the connection between the first connector and the slot is a slidable connection and the connection between the second connector and the notch is a pivotable connection. The slot can be a first slot and the body includes a second slot opposite to the first slot, with the step of coupling the first support component including engaging the first connector with the second slot. In addition, the notch can be a first notch and the body includes a second notch opposite to the first notch, with the step of coupling the second support component including engaging the second connector with the second notch. In one embodiment, the first connector has a first end and a second end, the first end of the first connector being inserted into the first slot before the second end of the first connector is inserted into the second slot.

In another embodiment, a method of adjusting a holder for an electronic device is disclosed. The holder includes a body configured to be coupled to the electronic device, the holder including a support movable between a retracted position and at least two extended positions relative to the body, the support being disposed within the body in its retracted position and extending from the body in its extended positions, the first support component including a first connector coupled to the body and the second support component including a second connector coupled to the body. The method includes the steps of: moving the first connector along the body from a retracted position to an extended position, the first support component being disposed in a retracted position when the first connector is in its retracted position and in an extended position when the first connector is in its extended position; and moving the second support component about the second connector relative to the body from a retracted position to an extended position.

In one implementation, the step of moving the first connector along the body from a retracted position to an extended position includes sliding the first connector along the body. The body includes at least one slot and the step of moving the first connector includes moving the first connector along the at least one slot. In on embodiment, the second connector is pivotally coupled to the body and the step of moving the second support component includes rotating the second support component about the second connector. In one embodiment, the extended position is a first extended position and the method includes moving the first connector along the body from the first extended position to a second extended position different than the first extended position. The second support component can be rotated about the second connector simultaneously with the movement of the first connector between its retracted position and either of its first extended position and its second extended position.

### BRIEF DESCRIPTION OF THE DRAWINGS

Other objects, features, and advantages of the present invention will become more apparent from the following detailed description of the different embodiments and certain modifications thereof when taken together with the accompanying drawings in which:

FIG. 1 is a schematic diagram of an embodiment of a holder or case according to the invention.

FIG. 2 is a perspective view of the hard case for the iPhone®, iPod Touch®, other iPods®, other handheld cell phones, electronic books, electronic tablet computers and other portable video/music players according to one embodiment of the present invention.

FIG. 3 is an end view of the case illustrated in FIG. 2 with its support in a deployed configuration.

FIG. 3A illustrates a rear perspective view of the holder illustrated in FIG. 3 with its support in a deployed configuration.

FIG. 3B illustrates a rear perspective view of the holder illustrated in FIG. 3 with its support in another deployed configuration.

FIG. 4 is an end view of the case illustrated in FIG. 2 with its support in a retracted configuration.

FIG. 5 is a rear perspective view of the case illustrated in FIG. 4 with its sound reflector extended.

FIG. 6 illustrates a front perspective view of the case illustrated in FIG. 5 with an electronic device coupled thereto.

FIG. 7 illustrates a perspective view of an alternative embodiment of a holder with an optional built-in cord management feature.

FIG. 8 illustrates a perspective view of the holder illustrated in FIG. 7 with a cord coupled thereto.

FIG. 9 illustrates rear perspective view of an alternative embodiment of a holder.

FIG. 10 illustrates a front view of the holder illustrated in FIG. 9.

FIG. 11 illustrates a rear view of the holder illustrated in FIG. 9.

FIG. 12 illustrates a perspective view of a support component of the holder illustrated in FIG. 9.

FIG. 13 illustrates a perspective view of another support component of the holder illustrated in FIG. 9.

FIG. 14 illustrates a side view of the holder illustrated in FIG. 9.

FIG. 15 illustrates another side view of the holder illustrated in FIG. 9.

FIG. 16 illustrates a cross-sectional view of the holder illustrated in FIG. 11 taken along the line “16-16.”

FIG. 17 illustrates a cross-sectional view of the holder illustrated in FIG. 11 taken along the line “17-17.”

FIG. 18 illustrates a rear perspective view of the holder illustrated in FIG. 9 with its support in a deployed configuration.

FIG. 19 illustrates a close-up view of some of the components of the holder illustrated in FIGS. 9 and 18.

FIG. 20 illustrates a rear view of the holder illustrated in FIG. 18.

FIG. 21 illustrates a front view of the holder illustrated in FIG. 18.

FIG. 22 illustrates a side view of the holder illustrated in FIG. 18.

FIG. 23 illustrates another side view of the holder illustrated in FIG. 18.

FIG. 24 illustrates an end view of the holder illustrated in FIG. 18.

FIG. 25 illustrates another end view of the holder illustrated in FIG. 18.

FIG. 26 illustrates a cross-sectional end view of the holder illustrated in FIG. 20 taken along the line “26-26.”

FIG. 26A illustrates a partial cross-sectional end view of the holder illustrated in FIG. 20.

FIG. 26B illustrates a partial cross-sectional end view of an alternative embodiment of the holder illustrated in FIG. 20.

FIG. 26C illustrates a partial cross-sectional end view of a portion of an alternative embodiment of the holder illustrated in FIG. 20.

FIG. 27 illustrates a rear perspective view of the holder illustrated in FIG. 9 with its support in another deployed configuration.

FIG. 28 illustrates an end view of the holder illustrated in FIG. 27.

FIG. 29 illustrates a cross-sectional end view of the holder illustrated in FIG. 27 taken along the line “29-29.”

FIG. 30 illustrates a rear perspective view of an alternative embodiment of a holder.

FIG. 30A illustrates a partial perspective view of some components of the holder illustrated in FIG. 30.

FIG. 30B illustrates a view of a surface of the holder illustrated in FIG. 30.

FIG. 30C illustrates a view of an alternative embodiment of a surface of the holder illustrated in FIG. 30.

FIG. 30D illustrates a perspective view of the surface illustrated in FIG. 30C.

FIG. 31 illustrates a rear perspective view of an alternative embodiment of a holder with its support in a retracted configuration.

FIG. 32 illustrates a rear perspective view of the holder illustrated in FIG. 31 with its support in a deployed configuration.

FIG. 33 illustrates a rear perspective view of an alternative embodiment of a holder with its support in a deployed configuration.

FIG. 34 illustrates a perspective view of an embodiment of an attachment mechanism for coupling a support to a surface.

FIG. 35 illustrates a cross-sectional side view of the attachment mechanism illustrated in FIG. 34 being coupled to the support.

FIG. 36 illustrates a perspective view of an alternative embodiment of an attachment mechanism for coupling a support to a surface.

FIG. 37 illustrates a cross-sectional side view of the attachment mechanism illustrated in FIG. 36 being coupled to the support.

FIG. 38 illustrates a schematic diagram of an embodiment of a mounting structure useable with a holder.

FIG. 39 illustrates a perspective view of an embodiment of a mounting structure useable with a holder.

### DETAILED DESCRIPTION OF THE INVENTION

The term “electronic device” is used to include any type of electronic device, including those identified above as examples of electronic devices with which the holder can be used. The terms “support” and “support portion” may be used interchangeably herein along with the term “support assembly” to refer to a structure that can be used to prop up or stand up the holder and an electronic device coupled to the holder relative to a support surface. The terms “case” and “holder” may be used interchangeably herein to refer to a structure that can be coupled to an electronic device and facilitate the transportation, use or support of the electronic device and in addition, provide protection for the electronic device. The term “pin” is used to include any type of protrusion that can be used to engage a slot, including a metal, plastic or other pin, as well as a simple bump of material that juts out from one component of a holder to engage with another component part of the holder. The term “connector” can be used interchangeably with the term “pin.” As used herein, the term “pin” includes a single connector or a set of corresponding connectors that can be used to couple one component to another component. The term “LCD” is used to include any type of display or screen of the device, including an OLED screen.

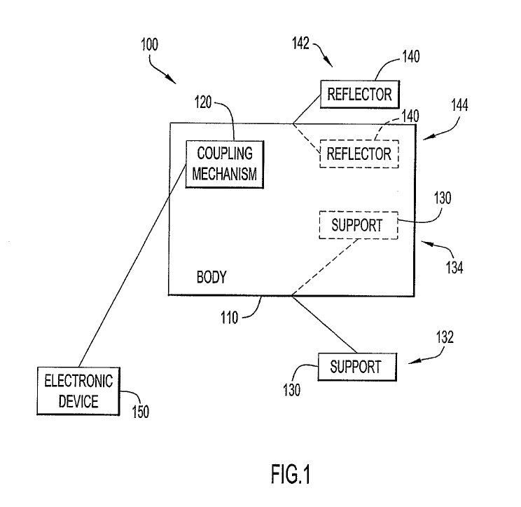

Referring to FIG. 1, an embodiment of a holder or case for an electronic device according to the invention is illustrated. In this embodiment, the holder 100 includes a body or body portion 110 that has a coupling member or mechanism 120. The coupling mechanism 120 can be used to couple the body 110 to an electronic device 150. The body 110 can be configured to provide protection to at least part of the electronic device 150. In different embodiments, the coupling mechanism 120 includes one or more coupling members that engage the electronic device 150. In one implementation, the coupling mechanism 120 may include two coupling members that engage different portions of the electronic device 150. In another implementation, the coupling mechanism 120 may include four coupling members that engage different portions, such as the corners, of the electronic device 150.

In this embodiment, the coupling mechanism 120 is integrally formed with the body 110 of the holder 100. However, in alternative embodiments, the coupling mechanism 120 is formed separately from the body 110 and subsequently coupled to connected thereto.

As shown in FIG. 1, the holder 100 includes a support 130 that is coupled to the body 110. The support 130 is engageable with a support surface, such as a table, counter, tray, desk, etc., and is configured to support the body 110 and the holder 100 via the support surface when the electronic device 150 is coupled to the body 110. The support 130 is movable relative to the body 110 and disposable in several different positions relative to the body 110. The support 130 may be slidable and/or pivotable relative to the body 110.

The support 130 can be placed in an extended position 132 in which the support 130 extends outwardly from the body 110 and is engageable with a support surface. The support 130 can also be placed in a retracted position 134 in which the support 130 is disposed within the body 110 (shown in phantom). The body 110 has a thickness and a profile in which the support 130 is contained or located when the support 130 is in its retracted position 134. The support 130 in its retracted position 134 has a collapsed thickness that is the same or substantially the same as the thickness of the body 110.

For example, in one embodiment, the body 110 has an opening formed therein. The support 130 is dimensioned to fit within the opening of the body 110 when the support 130 is in its retracted position 134. By disposing the support 130 within the body 110 or the profile of the body 110, the support 130 does not extend from the body 110 in its retracted position 134. Accordingly, a smooth and non-obtrusive profile for the body 110 is achieved. In the event that the body 110 has a curved configuration, the support 130 has a similarly curved configuration. In an alternative embodiment, substantially all of the support 130 is placed within the body 110 and only a very minor portion extends therefrom.

In one embodiment, the holder 100 includes a sound or audio reflector 140 coupled to the body 110. In different embodiments, the holder 100 may not include the reflector 140. Referring to the embodiment illustrated in FIG. 1, the reflector 140 is coupled to and movable relative to the body 110. The reflector 140 is shaped or configured so that audible output from the electronic device 150 is reflected off of a surface of the reflector 140 and in a direction desired by the user. In many implementations, the electronic device 150 includes a speaker or transducer proximate to its rear surface along which the body 110 of the holder 100 is placed. Typically, the user is located on the front of the device 150 when viewing the screen of the device 150. Accordingly, it is desirable that the audible output of the device 150 be reflected toward the front of the device 150 toward the user.

The reflector 140 is located proximate to the location of the speaker on the electronic device 150. The reflector 140 forms a part of the body 110 and is movable between an extended position 142 in which audible outputs are reflected off the reflector 140 and a retracted position 144 within the body 110 of the holder 100. In its retracted position 144, the reflector 140 is positioned within a recess or opening formed in the body 110 and disposed within the body 110.

In one embodiment, the body 110, the coupling mechanism 120, the support 130, and the reflector 140 can be formed of a molded plastic material. In one embodiment, each of the support 130 and the reflector 140 is slidably coupled to the body 110. In other embodiments, one or both of the support 130 and the reflector 140 is pivotally coupled to the body 110.

As described above, the invention includes a versatile hard case for cell phones such as the iPhone®, portable video/music players such as the iPod Touch® or other iPods®, and other handheld cell phones and portable video/music players. In one embodiment, the case allows wearing of the device on a belt clip as well as placement on any surface for hands-free viewing, with full adjustment of viewing angle in landscape orientation as well as viewing in portrait orientation with a more limited degree of angular adjustment. The hard case is especially suited for any handheld device with a frontal LCD, OLED, or other type of display including a touch-viewing screen.

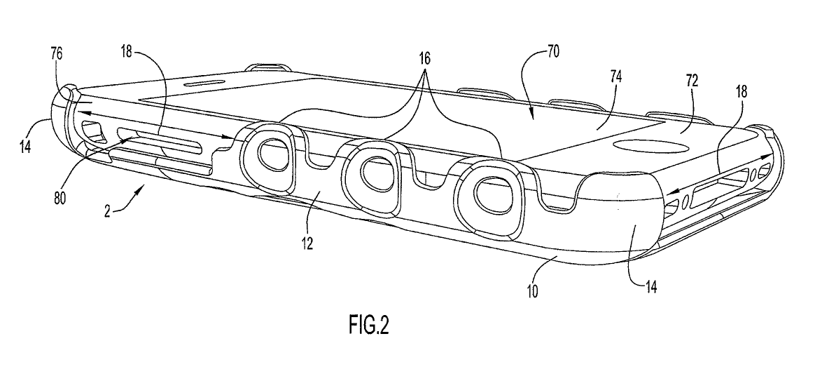

FIG. 2 is a perspective view of the hard case 2 according to one embodiment of the present invention. The hard case 2 is illustrated as being mounted to an electronic device 70 that has a front surface 72 with a display or display screen 74 and a side wall or portion 76 that extends around the perimeter of the front surface 72. The electronic device 70 includes a rear surface (not shown in FIG. 2) opposite the front surface 72. The electronic device 70 includes one or more ports 80 that facilitate the connection of the electronic device 70 to other components.

The hard case 2 includes a molded form-fitting backplate 10 with moderately raised upwardly curving edges 12 and four more pronounced and corner-positioned clamps 14 that furl over for cradling the device 70 at the corners of the device 70. The edges 12 are interrupted as necessary by apertures 18 to provide access to input/output ports, power keys and other controls side mounted on the device 70, such as port 80. While the specific configuration of the apertures 18 may vary depending on the device 70 with which the hard case 2 will be used, in one embodiment, the apertures 18 are duplicated in mirror-image fashion on both sides to allow insertion and use of the device 70 in either 180-degree rotated orientations.

Similarly, mirror-image apertures may be provided for device camera lenses. In addition to corner clamps 14, an offset series of grippers 16 is positioned along each side of backplate 10, likewise in mirror image fashion. Each gripper 16 comprises an upwardly furled oval flange defined by a central aperture. The grippers 16 may be integrally molded and impart a resilient sidelong bias against the device 70, working in conjunction with the corner-positioned clamps 14 to securely seat the device 70 and clamp it in place within the backplate 10. It is important that the grippers 16 and clamps 14 extend up to but not in advance of the device LCD 74 so as not to obstruct viewing and/or touch screen access, and also to allow the user to wipe the LCD 74 clean with a cloth or against a shirtsleeve.

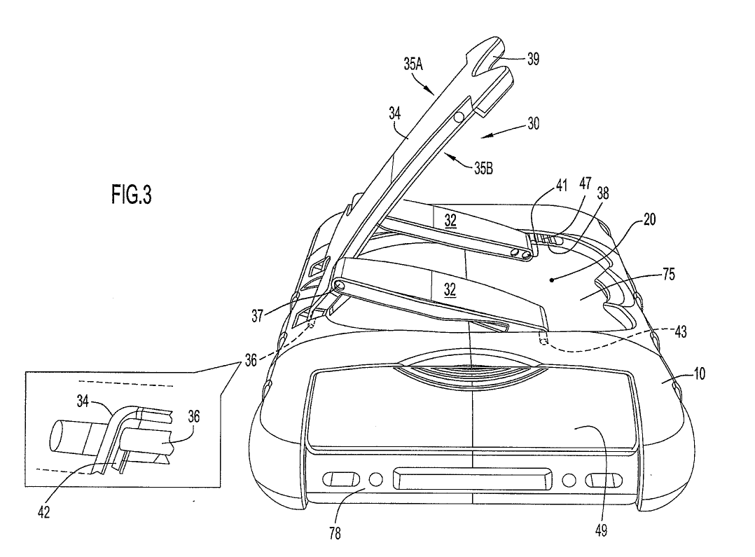

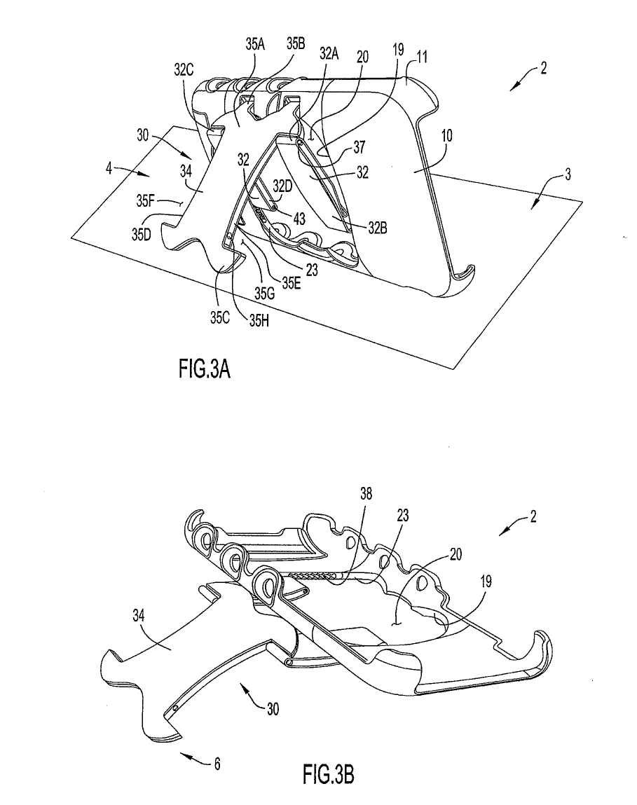

Referring to FIG. 3, a rear perspective view of the case 2 and the electronic device 70. The electronic device 70 has a rear surface 75 and an end 78 as shown. A major central portion of the backplate 10 is defined by a rear aperture 20, here rectangular, that seats a folding kickstand assembly or support 30. In other embodiments, the size and configuration of the aperture 20 can vary.

The kickstand assembly or support 30 is a novel and fully-adjustable mechanism for upright hands-free viewing of the device 70 at any angle as well as landscape or portrait viewing, while also serving as a hands-free shoulder cradle for speaking into a cell phone contained therein. In FIG. 3, the support 30 is illustrated in a deployed or extended position or configuration relative to the case 2. The kickstand assembly or support 30 further comprises a stand member 34 formed in the shape of an I (with opposing sidelong notches 35A and 35B) and pivoted at one end to the backplate 10. The support 30 also includes opposing reinforcing struts 32 that fit within the sidelong notches 35A and 35B and thereby fold flat with the stand member 34 when the support 30 is placed in its retracted position. In the retracted position, the stand member 34 and struts 32 fit together flush within the aperture 20 of the backplate 10.

The stand member 34 is pivotally coupled to the backplate 10 on one side of the rear aperture 20 by a first pivot pin 36 that traverses the stand member 34. The pin 36 enters notches 42 formed in the backplate 10 on opposing sides of aperture 20. The reinforcing struts 32 are pivotally coupled to the stand member 34 on opposing sides by a second pivot pin 37 that traverses the stand member 34, protruding outward into the sidelong notches on opposing sides of stand member 34 to anchor the reinforcing struts 32 therein. The other ends of reinforcing struts 32 are slidably anchored in channels 38 formed in the backplate 10 on opposing sides of aperture 20 by pivot pins 41, 43 that traverse the respective struts 32, entering the slots or channels 38 formed in the backplate 10 on opposing sides of its aperture 20. This way, the stand member 34 when folded inward seats within the aperture 20 in the backplate 10 and draws the reinforcing struts 32 down into the backplate aperture 10 for an entirely flush-folded slimline configuration.

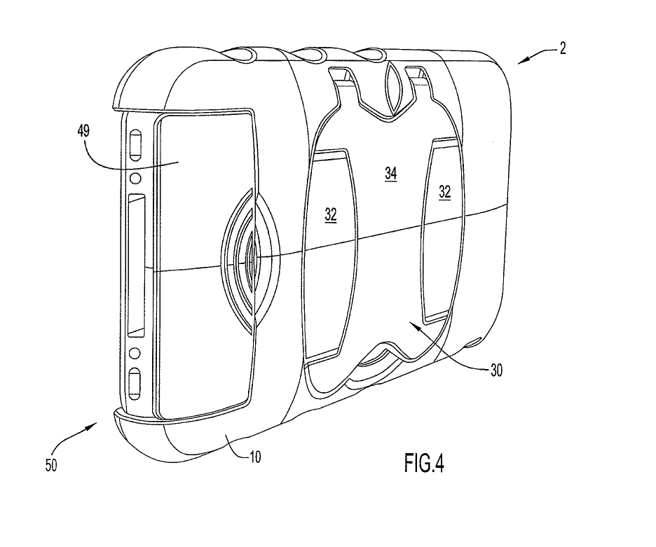

Referring to FIG. 4, a flush-folded slimline configuration of the case 2 is illustrated. As shown, the components of the kickstand assembly or support 30 (including the struts 32 and the stand member 34) are disposed within the aperture 20 of the backplate 10 and within the profile of the backplate 10.

Conversely, when the stand member 34 is unfolded outward it angles away from the backplate 10 and draws the reinforcing struts 32 outward, thereby serving as a structurally sound kickstand for inclined hands-free viewing. The desired angle can be adjusted and fixed by the user. These opposing slots or channels 38 are internally indexed with a series of serrated notches 47 (see FIG. 3) to provide an indexed sliding motion for pins 41, 43. Thus, when the stand member 34 is unfolded outward, it draws the reinforcing struts 32 outward, and the opposing channels 38 provide an indexed adjustment feature that selectively locks the pins 41, 43 and hence the angle of the stand member 34 at any desired angle along the entire length of the opposing channels 38. The user can set the viewing angle of the device 70 as desired.

Referring to FIGS. 3A and 3B, the holder 2 is illustrated with its support 30 in deployed configurations. The base plate 10 includes an edge 19 that defines the opening 20 through the plate 10. The body 10 includes a coupling mechanism 11 that includes several wall portions that are configured to engage an electronic device. The edge 19 includes opposite side walls (only side wall 23 is shown). Side wall 23 includes the slot or channel 38 formed therein. The opposite side wall includes a corresponding slot.

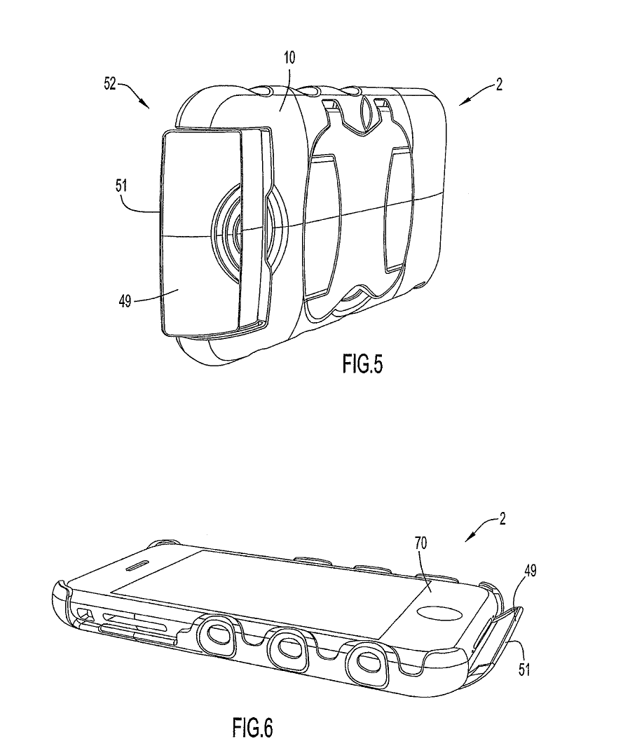

The support 30 can be placed in a retracted configuration (see FIG. 4) and in extended positions 4 (see FIG. 3A) and 6 (see FIG. 3B). The support 30 includes a support component 34 that has a body 35A that has an end 35B pivotally coupled to the body 10 by one or more pins (not shown). The body 35A also includes an end 35C that is used to contact a support surface 3 as shown. The body 35A includes side walls 35D and 35E that define notches 35F and 35G. Located along side wall 35D is a locking mechanism 35H, which can be a projection or a recess.

The struts 32 of the support 30 can be referred to alternatively as support components. One strut includes ends 32A and 32B that are coupled to the support component 34 and the body 10 by pins 37 and 43, respectively. Similarly, the other strut 32 includes ends 32C and 32D that are coupled to the support component 34 and the body 10 by pins 37 and 41, respectively.

If a user decides that he or she prefers to wear the device on their belt rather than in a pocket, the stand member 34 may be formed with a central recess configured for latching a belt clip (not shown) in place, so that the belt clip can be externally attached when the stand member 34 and reinforcing plates or struts 32 are fully folded inward (both seated flush within the aperture 20 in the backplate 10). This allows the flush-folded case 2 to be worn on the belt.

Referring to FIG. 3, note that the bottom of the stand member 34 is formed with an arch 39 designed to conform to the shoulder of a user. This allows the case 2 to be used as a hands-free shoulder support when using the device as a cell phone. The arch 39 conforms to the user's shoulder, and allows the device to be cradled between the head and shoulder when speaking.

As seen in the lower inset of FIG. 2, notches 42 are formed in the stand member 34 on opposing sides for ingress and receipt of pivot pin 36. These notches 42 are specially-formed quick-release notches having a keyslot cross-section with a forwardly protruding notch. This facilitates assembly of the pin 36 into notch or slot 42 inasmuch as the pin 36 can be angled into the notch 42 more easily and snapped in place. It also avoids breakage of the kickstand assembly or support 30 since upon severe shock the kickstand 30 will simply dislodge at the pin 36 (rather than breaking), and can then be reassembled.

It should now be apparent that the above-described hard case 2 is highly versatile inasmuch as the side grippers 16 clamp around the device without obscuring the display or controls, the case 2 allows the device to be inserted in either 180 orientations without compromising usability, and the adjustable kickstand or support 30 allows adjustment of the viewing angle within a broad range, as well as landscape or portrait viewing. When standing on end the kickstand assembly or support 30 protrudes rearwardly enough to still support the device at an incline.

Given the angular adjustment shown in FIG. 3 the hard case 2 can be supported at an 80 degree (offset from horizontal) viewing angle, presenting the user with a perfect frontal perpendicular view of the LCD 74. If, on the other hand, the user is seated on an airplane and is peering down to the device 70 seated on an airline tray from above, the kickstand assembly 30 can be readjusted to provide a more appropriate viewing angle, such as a 20 degree (offset from horizontal) viewing angle. Despite this versatility, the hard case 2 can be folded flat into an extremely low profile to facilitate pocket insertion, or for use with a detachable belt clip for wearing.

Referring to FIG. 3, the case 2 includes a slide-panel or noise shield 49 that is movably coupled to the backplate 10 of the case 2. FIG. 4 is a side perspective view, and FIG. 5 is a top perspective view, of the back of the hard case 2 illustrating a slide-panel 49 that serves as a noise shield. Since both the microphone and the speaker for an iPhone® mobile digital device, and other electronic devices, are located on bottom of phone or device, it can be difficult for these phones to pick up the user's voice, yet easy to pick up room noise. This is especially true when using the external speaker of an iPhone® mobile digital device, and the sound tends to seem low unless you hold bottom of phone directly at you. The noise shield 49 is a sliding panel that extends endwise outward from the bottom of phone. In one embodiment, the noise shield 49 extends about one-half inch (A″). The noise shield or panel 49 is curved to conform to the contour of the bottom end of the hard case 2. In this embodiment the panel slides between a retracted position and an extended position. In other embodiments, this movement could be accomplished by twisting, flipping, pivoting, or bending the slide-panel 49 between one position and the other. Further, there could be multiple extended positions.

Thus, in its closed position the iPhone® mobile digital device will function normally and can even be docked. To open, the noise shield 49 slides outward in an arc creating a pocket from the bottom of phone about one-half inch (½″). The pocket channels sound, in one sense to reduce ambient room noise by shielding the microphone from surrounding noise. In addition, the pocket deflects sound outward from the iPhone's external speaker, bouncing it back towards the front face of phone instead of straight out the bottom of phone. This makes the external speaker sound appear louder, while also deflecting the user's own voice back into the microphone. In alternative embodiments, the shield or panel 49 extends a distance different than one-half inch from the device 70 and case 2.

Referring to FIG. 4, the shield or panel 49 is disposed in its retracted position 50 relative to the backplate 10. Referring to FIGS. 5 and 6, the shield or panel 49 is disposed in an extended or reflecting position 52 relative to the backplate 10. In this position, an outer edge or end 51 of the panel 49 extends beyond the end of the case 2.

Referring to FIGS. 7 and 8, an alternative embodiment of a case is illustrated. FIGS. 7 and 8 are views of an alternative embodiment of a hard case 200 similar to the foregoing case 2 but with an optional built-in cord management feature. As shown in FIG. 7, the cord management feature or mechanism 210 includes four outwardly-pivoting corner tabs 220 installed into apertures 230 in each of the four corners of the hard case 200. Each of the apertures 230 is formed in a corner of the hard case 200 and simply conforms to the body of each corresponding tab 220, thereby providing a flush seating. Each of the tabs 220 conforms outwardly to the contours of the hard case 200 so as to provide a seamless aesthetic when folded. Each tab includes opposing coaxial pins (which may be integrally molded) that pivotally attach inside corresponding holes in the apertures 230. This way, a user can on demand flip the tabs 220 outward from a stowed/flush position to a deployed position (as shown), whereupon they collectively serve as a cord storage reel as shown in FIG. 8.

Standard audio output cords or power cords can be conveniently wound to avoid clutter. Furthermore, channeled ribs 240 may be provided as shown at the top center and/or bottom center (other at other locations) of the hard case 200 to channel the cord 250 and releasably secure it in place by a press-fit. As an alternative to the foregoing, cord management can also be obtained by pre-forming a recessed channel that runs about the edges of the hard case 200, thereby allowing a cord to be wrapped inside. Note that this same channel in the manner of a picture frame might be hinged at one point (e.g., at one corner) and also serve the purpose of an adjustable kickstand.

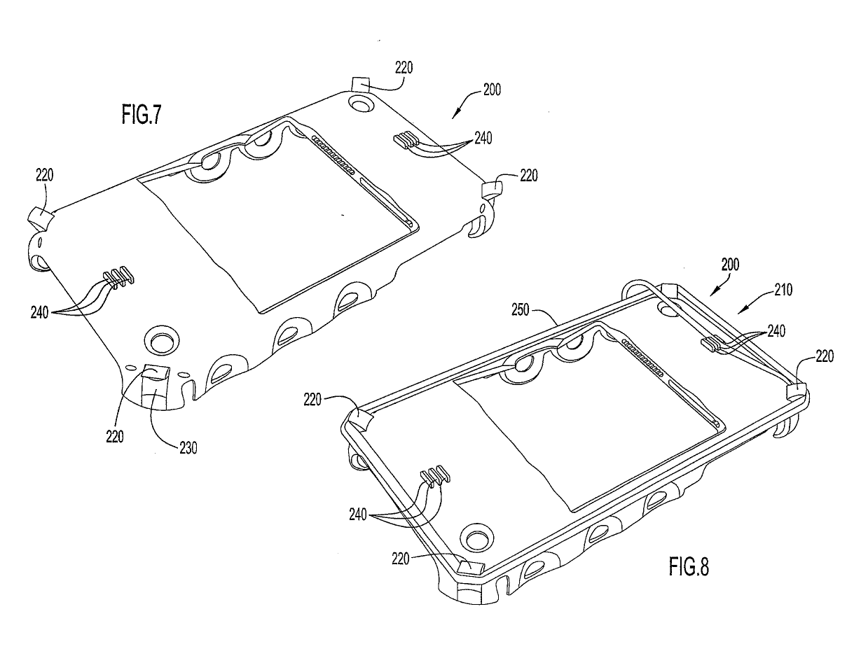

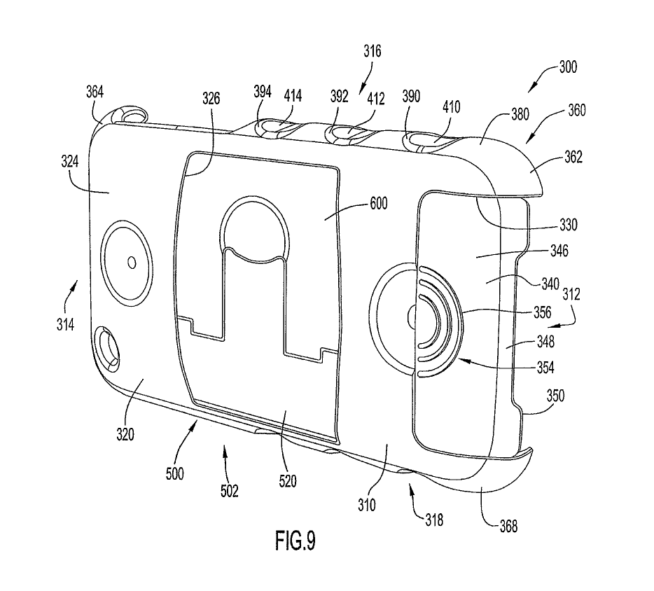

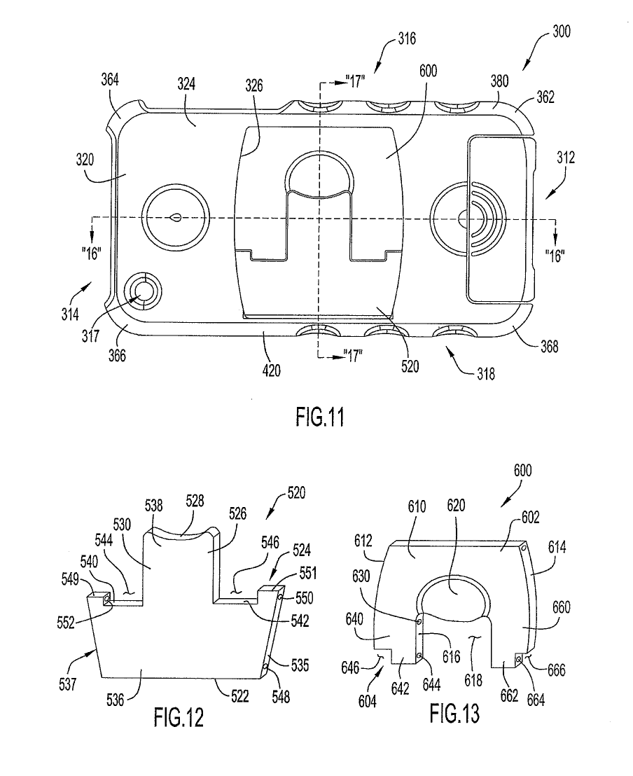

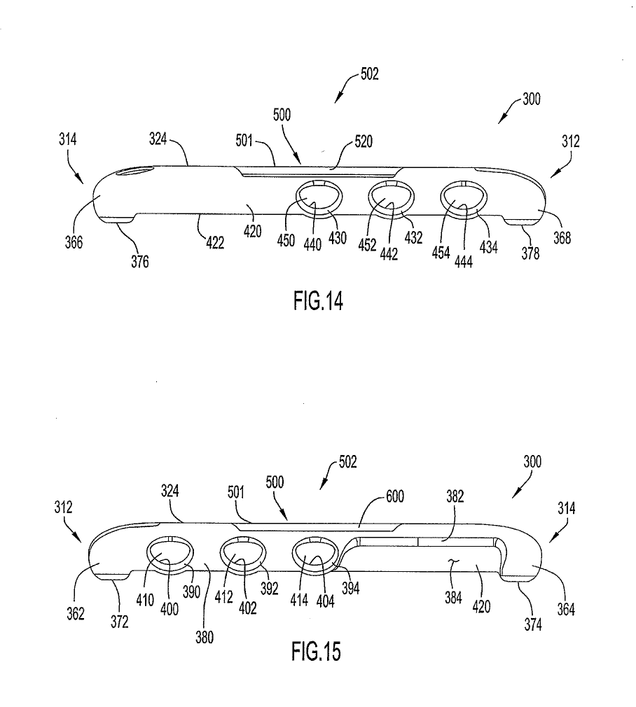

Referring to FIGS. 9-17, an alternative embodiment of a case or holder is illustrated. Referring to FIGS. 9-11, a rear perspective view of the case or holder 300, a front view of the case, and a rear view of the case, respectively, are illustrated. In this embodiment, the holder 300 includes a body or base 310 that is molded using a plastic material. In an alternative embodiment, the base 310 of the holder 300 can be formed of metal. The body or base 310 can be referred to alternatively as a mounting portion. The body 310 has opposite ends 312 and 314 and opposite sides 316 and 318. The body 310 includes a rear plate or base plate 320 that has an inner surface 322 (see FIG. 10) and an outer or rear surface 324 (see FIGS. 9 and 11). The inner surface 322 and the outer surface 324 of the plate 320 define a thickness therebetween. As shown in FIG. 14, the plate 320 includes an opening 317 formed therethrough that is aligned with a camera eye or opening on the electronic device coupled to the holder 300.

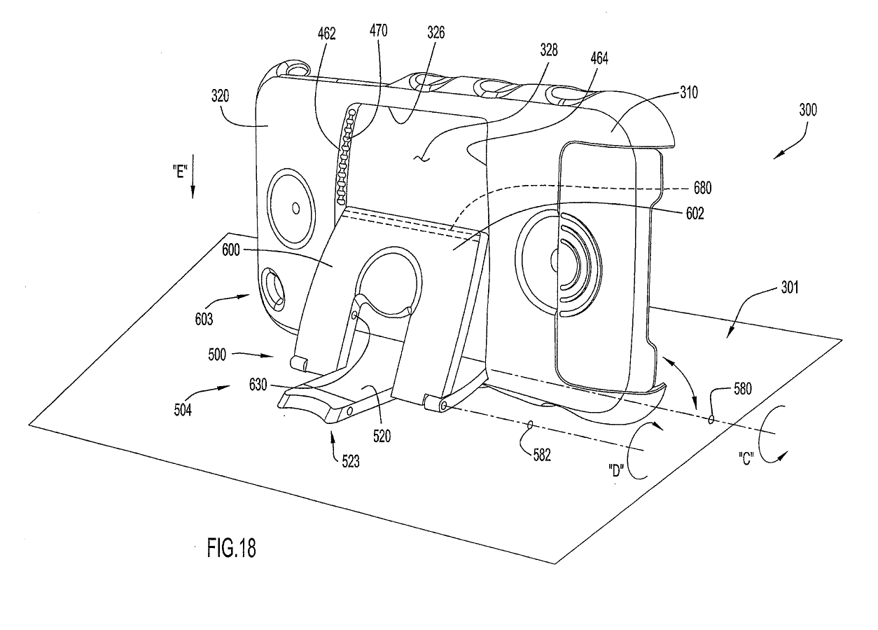

The plate 320 includes an edge 326 that defines an opening 328 (see FIG. 18). In this embodiment, the opening 328 is substantially centrally located on the plate 320. However, in other embodiments, the opening 328 may be offset along the plate 320 and may have a different shape or configuration than opening 328. The plate also includes an edge 330 that defines a recess 332 (see FIG. 9). The edge 330 and recess 332 are located proximate to end 312 of case 300.

As shown in FIG. 9, the case 300 includes a sound reflector 340 slidably coupled to the body 310. The reflector 340 is configured to be inserted into the recess 332 defined by edge 330. The reflector 340 includes a body portion 346 and a curved portion 348 with a distal end or edge 350. A series of grooves or ridges 356 form an engagement area 354 that can be engaged by a user's finger to move the reflector 340 relative to the body 310. Each of the opposite sides and the end of the body portion 346 includes a groove or slot formed therein that facilitates the sliding of the body portion 346 along the side walls forming the edge 330 that defines the recess 332. The friction fit of the reflector 340 in the recess 332 enables a user to position the reflector 340 in a desired position and have the reflector 340 remain in that position.

The sound reflector 340 includes a surface that is used to reflect audible outputs. In one embodiment, the sound reflector 340 is made of a material that has a higher density than the material of the rest of the holder 300. The higher density of the material increases the intensity at which sound is reflected off of the reflector 340. In an alternative embodiment, the sound reflector 340 includes a surface with a piece or layer of material coupled thereto that has a higher density (and improved reflecting properties) than the rest of the sound reflector 340. The additional piece of material can be adhered to or molded with the inner surface of the sound reflector 340. Thus, by changing the material of the sound reflector 340 relative to the holder 300 or by using a piece of material, such as metal, coupled to the sound reflector 340, the reflecting properties and characteristics of the sound reflector 340 are improved. In other words, the material used on the reflector 340 is more sonically reflective than the material of the body 310.

The case 300 also includes a coupling mechanism 360 that can be used to couple the case 300 to an electronic device. The coupling mechanism 360 is a releasable coupling mechanism so that a user can easily remove the case 300 from the electronic device when desired. The coupling mechanism 360 includes at least one coupling member. In this embodiment, the coupling mechanism 360 includes coupling members 362, 364, 366, and 368, each of which is located near a corner of the case 300 and a corner of the electronic device.

Referring to FIGS. 9 and 15, the coupling mechanism 360 includes a side wall 380 that is integrally formed with the base plate 320. In this embodiment, the side wall 380 includes several gripping members that facilitate the gripping of the case 300 by a user. The gripping members include openings 410, 412, and 414 that are defined by edges 400, 402, and 414, respectively, and surrounded by tapered surfaces 390, 392, and 394, respectively (see FIG. 15 for greater detail). The openings and tapered surfaces are sized to be engaged by a user's fingers. In other embodiments, the side wall 380 may include fewer or more openings or the side wall 380 may be formed with no such openings at all. As shown in FIG. 15, the side wall 380 also includes an edge 382 that defines an aperture or notch 384 that facilitates access to one or more ports or features of an electronic device coupled to the case 300.

Referring to FIGS. 10 and 14, the coupling mechanism 360 includes a side wall 420 that is integrally formed with the base plate 320. In this embodiment, the side wall 420 extends between coupling members or corner portions 366 and 368 along the length of plate 320. As shown in FIG. 14, the side wall 420 includes an edge 422 and several openings 450, 452, and 454 that are defined by edges 440, 442, and 444, respectively, and surrounded by tapered surfaces 430, 432, and 434, respectively. The openings and tapered surfaces are configured to be engaged by one or more fingers of a user. In different embodiments, the quantity of openings formed in the side wall 420 can vary.

Referring to FIGS. 9-11, the holder 300 includes a support or support portion 500 coupled to the body 310. The support 500 can be referred to alternatively as a stand or kickstand assembly. The support 500 is configured to be used to support the body 310 at one or more orientations relative to a support surface 301 (as shown in FIG. 18). The support 500 includes two support components 520 and 600. As discussed in detail below, support component 520 is coupled to the body 310 and to support component 600 and the support component 600 is coupled to the body 310 and to support component 520. The support 500 is illustrated in a retracted or collapsed configuration 502 in FIGS. 9-11.

As shown in FIG. 10, the components 520 and 600 are visible and accessible from the inner side of the case 300. When the support components 520 and 600 are moved to their collapsed or retracted positions, the support components 520 and 600 are substantially coextensive with the opening 328 in the plate 320 of the body 310. The support components 520 and 600 are sized and configured to collectively mate with the opening 328.

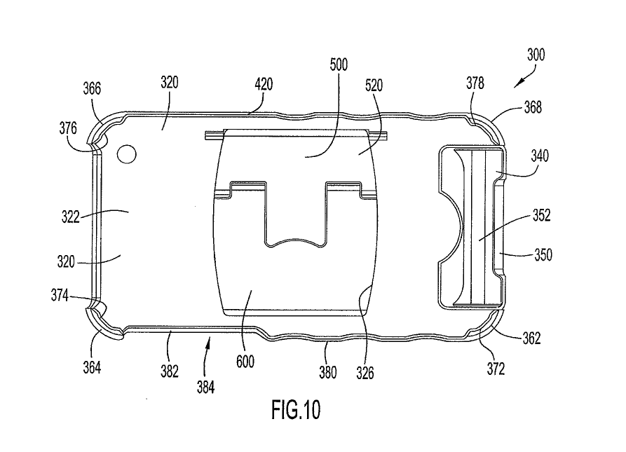

Referring to FIG. 12, a perspective view of an embodiment of support component 520 is illustrated. In this embodiment, the support component 520 includes a base portion 536 and an extension 538 integrally formed with the base 536. The support component 520 includes opposite ends or end portions 522 and 526 and an intermediate end or end portion 524. Ends 522 and 524 correspond to the ends of the base portion 536. The base portion 536 and extension 538 include an outer surface 530 that engages a support surface when the holder 300 is in use. The outer surface 530 forms a contact surface or area that engages a support surface and is used for support. In one embodiment, the outer surface 530 can be substantially planar. In another embodiment, the outer surface 530 can have a curved configuration. The base portion 536 and extension 538 include an inner surface 532 opposite to the outer surface 530.

As shown, the support component 520 includes edges 540 and 542 that define notches or recesses 544 and 546, respectively. The base portion 536 includes side walls 537 and 535 and mounting portions 549 and 551 that include openings 552 and 550 therethrough, respectively, through which couplers, such as pins, are inserted to couple support component 520 and support component 600. The base portion 536 also includes an opening 548 extending therethrough proximate to end 522 through which a pin or coupler can be inserted to couple the support component 520 to the body 310 of the case 300.

The extension 538 also includes an engagement portion 528 proximate to end 526. The engagement portion 528 includes a tapered portion that facilitates engagement of the support component 520 by a user, as described below. In other embodiments, the particular configuration of support component 520 can vary.

Referring to FIG. 13, a perspective view of an embodiment of support component 600 is illustrated. In this embodiment, the support component 600 includes a body 610 with side edges 612 and 614 and an inner edge 616 that defines a recess 618. An engagement surface 620 is formed in the body 610 to facilitate access to the engagement portion 528 of support component 520 by a user to move the support 500 from its retracted configuration to an extended configuration. The body 610 includes an inner surface 622 and an outer surface 624 opposite to the inner surface 622 (see FIG. 17) that define a thickness therebetween.

The support component 600 includes an extension 640 with an end portion 642 with an opening 644 therethrough. The end portion 642 also includes a notch 646. Along the inner surface of the extension 640 is a locking member 630 that is engaged with a corresponding locking member on support component 520 as discussed below. The support component 600 includes another extension 660 with an end portion 662 with an opening 664 therethrough. The end portion 662 also includes a notch 666 and a locking member (not shown). Couplers, such as pins, can be inserted through the openings 644 and 664 to couple support component 600 to support component 520. As discussed in greater detail below, the body 610 has an end 602 slidably coupled to the body 310 of the holder 300 and an end 604 that is pivotally coupled to support component 520.

Referring to FIGS. 14 and 15, the support 500 is illustrated in its retracted position or configuration 502. The support 500 has an outer surface 501 that together with the outer surface 324 of the body 310 forms a substantially continuous outer surface for the holder 300. Support component 520 is illustrated in FIG. 14 and support component 600 is illustrated in FIG. 15. As shown, coupling member 366 has a length that extends to an outer edge 376. The coupling member 366 has a curved configuration that curves around an edge of an electronic device. The edge 376 is located proximate to the front surface of the electronic device, but does not cover any of the front surface. As a result, the coupling member 366 provides protection for the electronic device by being located in the corner area, which is the portion of the electronic device that has the highest incidence of contacting a surface or object when the electronic device is dropped. In addition, because the edge 376 extends slightly above the plane of the front surface of the electronic device, protection is provided to the electronic device in the event that the front surface of the electronic device is oriented downwardly when dropped. Since the edge 376 does not cover the front surface of the electronic device, a user has full access to the front surface and can easily wipe the front surface clean. Coupling members 362, 364, and 368 are similarly configured to coupling member 366 and have edges 372, 374, and 378, respectively, that are configured the same as edge 376.

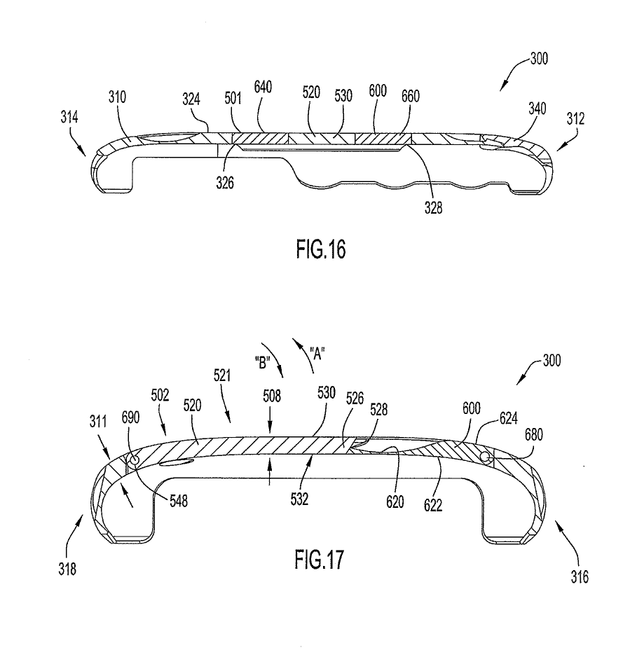

Referring to FIGS. 16 and 17, cross-sectional views of the holder 300 taken along the respective lines illustrated in FIG. 11 are shown. In FIG. 16, a length-wise cross-sectional view of the holder 300 is taken from end 312 to end 314. In FIG. 17, a side-to-side cross-sectional view of the holder 300 is taken from side 316 to side 318.

As shown in FIG. 16, the support 500 is disposed within the body 310 of the holder 300. In particular, the support 500 is disposed within the opening 328 defined by edge 326 in the plate 320 of body 310. The support 500 includes the extensions 640 and 660 of support component 600 and extension 530 of support component 520 which are all located within the profile of the body 310 of the holder 300 and in particular, within the opening 328. The outer surface 501 of the support 500 and its components is substantially continuous with the outer surface 324 of the body 310 and collectively, the surfaces 501 and 324 form a continuous or substantially continuous outer surface of the holder 300.

Referring to FIG. 17, a different view of the components of the support 500 is illustrated. The support component 520 has a thickness 508 that is defined by the inner surface 532 and the outer surface 530 of the support component 520. The body 310 has a thickness 311. The support component 520 is coupled to the plate 320 or body 310 by a pin 690 that is inserted through opening 548. The pin 690 allows the support component 520 to move or pivot relative to the body 310. Accordingly, the pin 690 defines an axis of rotation for the support component 520.

In FIG. 17, the proximity of the engagement surface 620 of support component 600 to engagement portion 528 of support component 520 is illustrated. The engagement surface 620 is recessed or has a concave configuration to allow a portion of a finger of a user to contact and engage portion 528 to move support component 520 along the direction of arrow “A” about pin 690 to an extended position. When the support 500 is to be collapsed, the support component 520 can be moved along the direction of arrow “B” about pin 690 to its retracted position 502 shown in FIG. 17. Support component 600 is coupled to the body 310 by a pin 680 that extends through an opening in the support component 600 and engaged with a slot in the body 310, as discussed below.

Referring to FIGS. 18-26, the holder 300 is illustrated in a deployed or use configuration. In this configuration, the support 500 of the holder 300 is placed in an extended configuration 504. As shown in FIG. 18, each of the support components 520 and 600 has moved relative to the body 310 from the configuration illustrated in FIGS. 9-17. In FIG. 18, the support component 520 is shown in an extended position 523. The support component 520 is moved from its retracted position 521 (see FIG. 17) around axis 580 defined by pin 690 along the direction of arrow “C” to its extended position 523. When the support component 520 is in this position, the outer surface 530 of the support component 520 engages a support surface 301 to prop up and support the body 310 of the holder 300 and any electronic device coupled to the holder 300. The range of motion of the support component 520 around axis 580 can vary.

As the support component 520 pivots about axis 580, the pivoting connection between the support components 520 and 600 results in support component 600 moving about axis 582 along the direction of arrow “D” relative to support component 520. Axis 582 is defined by the pins that couple the support components 520 and 600 together. In an alternate embodiment, Axis could be defined by a living hinge that would mate support components 520 and 600 together.

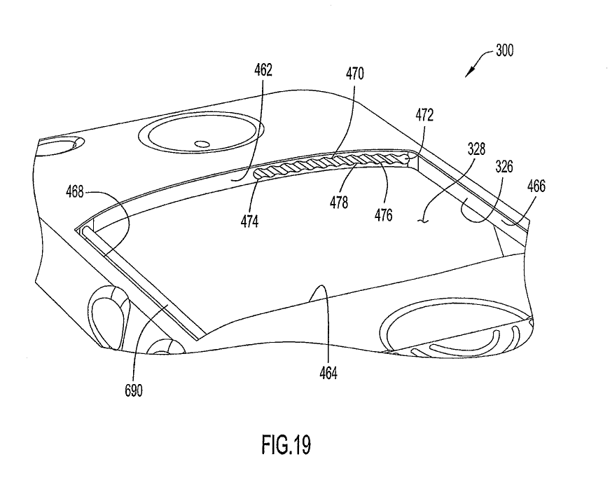

Referring to FIGS. 18 and 19, the edge 326 that defines opening 328 includes several side walls 462, 464, 466, and 468 that define the opening 328. The body 310 of the holder 300 includes a positioning mechanism that includes slots formed in side walls of the body 310. As shown, side wall 462 includes a slot 470 with ends 472 and 474 and a surface 476 extending between the ends 472 and 474 defining the upper and lower sides of the slot 470. Referring to FIG. 19, the surface 476 includes several projections or ridges 478 formed on the upper and lower portions of the surface 476. Similarly, side wall 464 includes a slot (not shown) with opposite ends and several projections or ridges formed therealong. Each of the projections or ridges 478 defines a position for pin 690 and as a result, defines a position for the support 500. As shown, more than three positions for the support 500 are defined by the quantity of the ridges 478. The end 602 of support component 600 is slidably coupled to the plate 320 via pin 680 that engages slot 470 on side wall 462 and the corresponding slot on side wall 464. The pin 680 engages the projections 478 which help retain the pin 680 in a particular location along the slot 470 along with the friction between the pin 680 and the surfaces of the slot 470. Also shown in FIG. 19 is the pin 690 that pivotally couples or mounts support component 520 to the body 310.

Referring to FIG. 18, as support component 520 rotates along the direction of arrow “C,” end 602 of support component 600 moves toward an extended position 603 along the direction of arrow “E” which is determined by the direction and configuration of the slots in the side walls 462 and 464. In one embodiment, the slots in the side walls 462 and 464 have a slightly curved configuration. The curved configuration of the slots changes the frictional force that is applied to the pin 680. The varying force and the projections in the slots enable support components 520 and 600 to be retained in a variety of positions relative to the body 310, thereby enabling the support or support stand to support the holder 300 at different angles and orientations relative to a support surface.

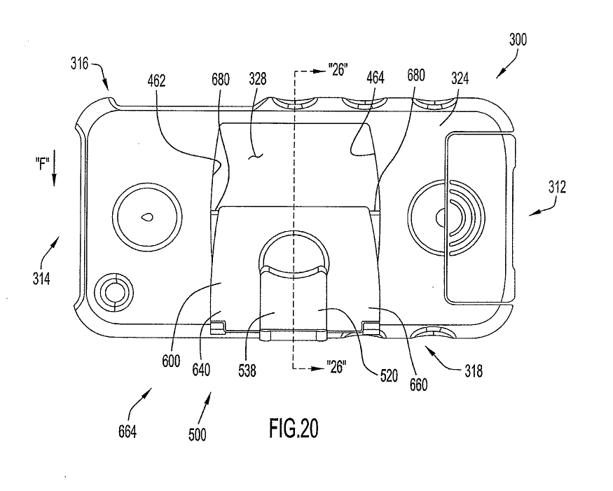

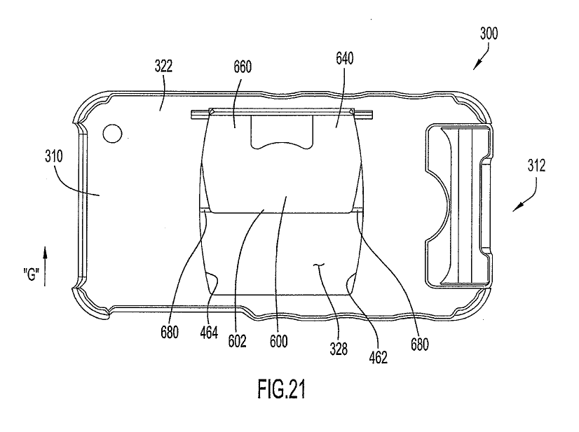

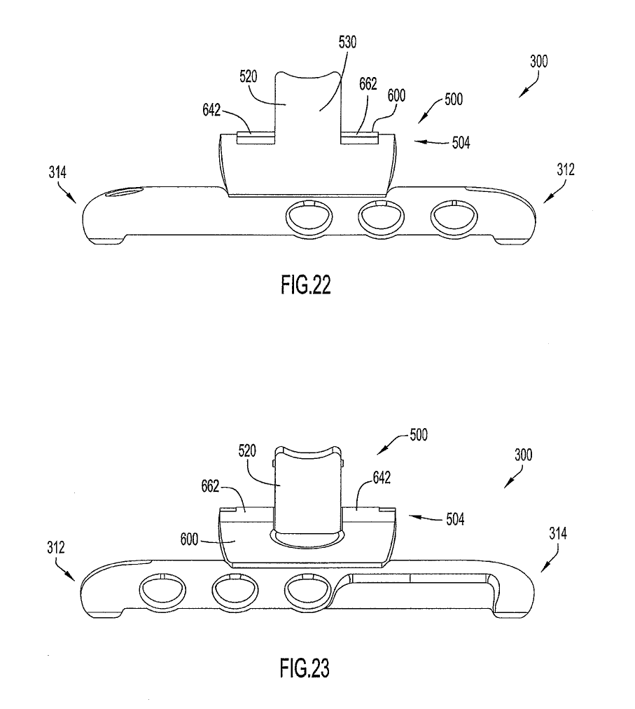

Referring to FIGS. 20 and 21, rear and front views of the holder 300 with the support 500 in its extended configuration 504 are illustrated, respectively. The pin 680 that engages the side walls 462 and 464 is shown and has been moved along the direction of arrow “F” in FIG. 20 and the direction of arrow “G” in FIG. 21. When the support components 520 and 600 move to their positions associated with extended configuration 504, a portion of the opening 328 is exposed as shown. Referring to FIGS. 22 and 23, left and right side view of the holder 300 with the support 500 in its extended configuration 504 are illustrated.

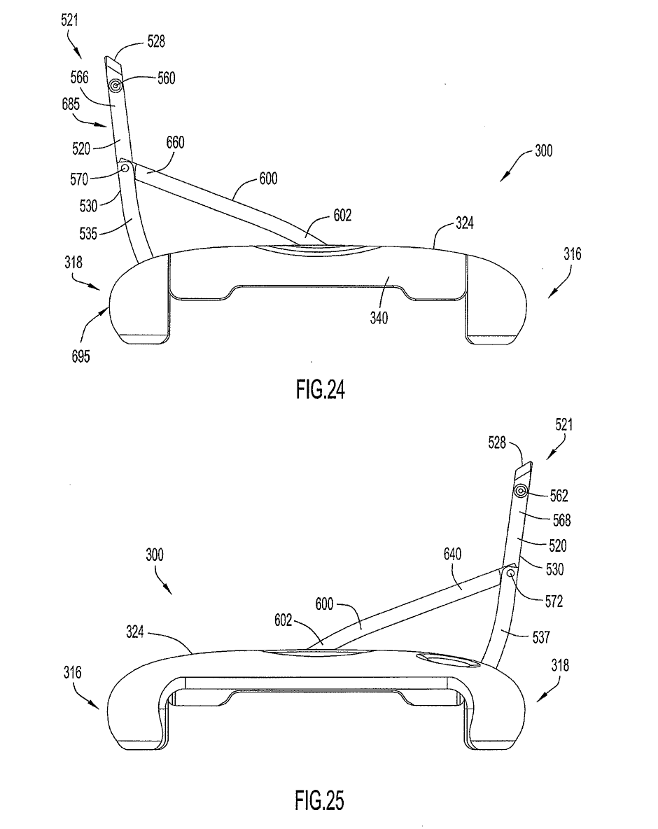

Referring to FIGS. 24 and 25, opposite end views of the holder 300 with the support 500 in its extended configuration 504 are illustrated. As shown in FIGS. 24 and 25, the support component 520 includes opposite side walls 535 and 537 for base portion 536 and opposite side walls 566 and 568 for extension 538. The side walls 566 and 568 include locking members 560 and 562, respectively. In this embodiment, each locking member 560 and 562 is a recess formed in the corresponding side wall 566 or 568. Each of the recesses 560 and 562 is configured to receive a corresponding projection on support component 600 when the support components 520 and 600 are placed in their retracted positions. As shown in FIG. 24, the support component 520 is placed in its extended position 521. The support component 600 is coupled to support component 520 by pins 570 and 572. The outer surface 530 forms a contact area or surface 685 that contacts a support surface along with contact area or surface 695.

Referring back to FIG. 18, support component 600 includes a locking member 630 that engages with locking member 562 on support component 520 and an opposite locking member (not shown) that engages with locking member 560 on support component 520. The locking members on support component 600 are projections that engage the recesses 560 and 562. In an alternative embodiment, the structure and the configurations of the locking members on the support components 520 and 600 can be reversed so that support component 520 includes projections and support component 600 includes corresponding recesses.

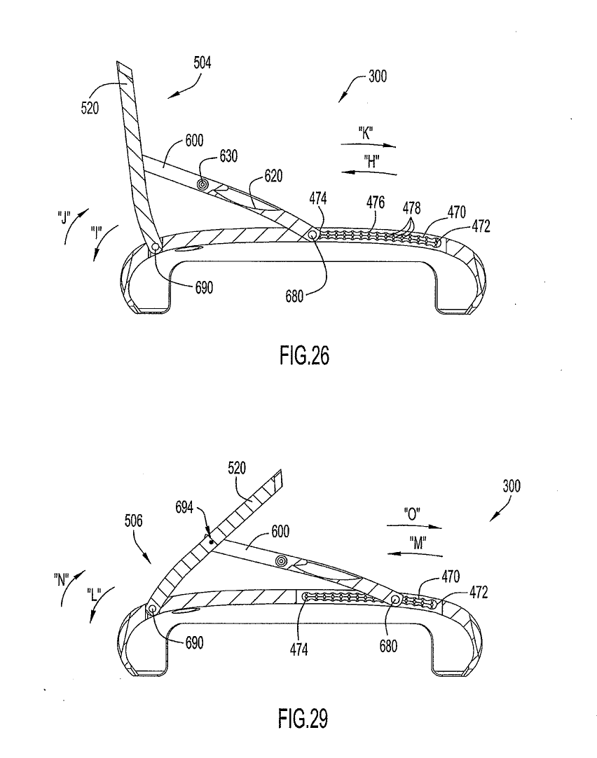

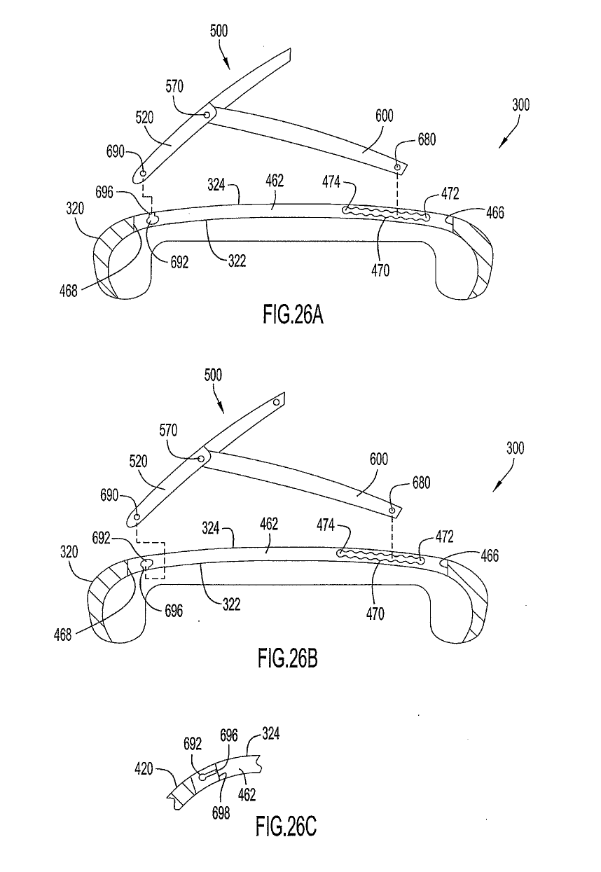

Referring to FIG. 26, a cross-sectional view of the holder 300 with the support 500 in its extended configuration 504 shown in FIG. 20 is illustrated. In this view, the details of slot 470 are illustrated. Slot 470 has opposite ends 472 and 474 and a surface 476 extending therealong. The surface 476 includes several projections or ridges 478 disposed along the surface 476. The pin 680 is moved along the slot 470 along the direction of arrow “H” as shown. At the same time, support component 520 moves about pin 690 along the direction of arrow “I.” In this view, locking member 630, in this embodiment a projection, on support component 600 is illustrated. To collapse the support 500, support component 520 is moved along the direction of arrow “J” about pin 690 and pin 680 moves along slot 470 along the direction of arrow “K.”

Referring to FIGS. 26A-26C, several different embodiments of a base plate 320 are illustrated and the assembly of the support 500 to the holder 300 is described. Referring to FIG. 26A, the base plate 320 of the holder 300 including side walls 462, 466, and 468 defining opening 328 is illustrated. As previously described, side wall 462 includes a slot 470 with opposite ends 472 and 474. The side wall opposite side wall 462 includes a similar slot formed therein. Proximate to side wall 468, side wall 462 includes an opening 696 that leads to a notch or receptacle 692. The width of the opening 696 is smaller than the width of the notch 692. In the embodiment, illustrated in FIG. 26A, the opening 696 leading to notch 692 is located on the outer surface 324 of the base plate 320. The side wall 468 opposite to side wall 462 has a similarly configured opening and notch arrangement that is used in the same manner as opening 696 and notch 692.

When the support 300 illustrated in FIG. 26A is to be assembled, support components 520 and 600 are coupled together and moved proximate to the opening 328 in the base plate 320. Initially, the pin 680 (or if more than one, the pins 680) coupled to support component 600 is connected to the base plate 320 and in particular, to the slots 470 in the base plate 320. One end of the pin 680 coupled to support component 600 is inserted into the slot 470. The support component 600 is moved at an angle relative to the base plate 320 so that the opposite end of the pin 680 can be inserted into the slot 470 formed in the opposite side wall 468. After support component 600 is slidably coupled to the base plate 320, support component 520 is then coupled to the base plate 320.

As previously described, support component 520 includes a pin 690 that is coupled thereto. In one embodiment, the pin 690 extends outwardly from opposite sides of the support component 520. The pin 690 can be inserted or snapped into the opening 696, which is sized slightly smaller than the diameter of the pin 690, and then moved into the notch 692. The pin 690 is retained in the notch 692 due to the smaller width of the opening 696. However, if sufficient force is applied to the support 500, the pin 690 can be dislodged and separated from the base plate 320 by moving through the opening 696 without damaging the base plate 320. Similarly, the opposite end of the pin 690 is inserted or snapped into an opening corresponding to opening 696 and moved to a notch corresponding to notch 692 formed in side wall 468.

Thus, when the support components 520 and 600 are coupled to the base plate 320, the connection between the connector or pin 680 is a slidable connection along the slot 470. As a result, the second support component 600 is slidable along the base plate 320 with some rotational movement about pin 680 as well as the connector 680 slides along the body 310. In addition, the connection between the connector or pin 690 is a pivotable connection. The first support component 520 rotates about the connector or pin 690 simultaneously as the connector 680 slides in the slot 470.

Referring to FIG. 26B, the coupling of the support components 520 and 600 to the base plate 320 is similar to that illustrated in FIG. 26A except that the opening 696 and notch 692 are oriented so that the opening 696 is located along the inner surface or face 322. In this embodiment, pin 690 can be moved proximate to the inner surface 322 and inserted or snapped into place in the notch 692. Alternatively, as shown in FIG. 26C, a separate wall 698 can be formed along a portion of the side wall 462. In this embodiment, the opening 696 and notch 692 are oriented so that the opening 696 is located along that wall 698. In this coupling implementation, the pin 690 is moved proximate to wall 698 and inserted into the opening 696 and the notch 692.

In each of the embodiments illustrated in FIGS. 26A-26C, the support component 600 is initially coupled to the base plate 320 via the slots 470 and the support component 520 is subsequently coupled to the base plate 320 via notches 692.

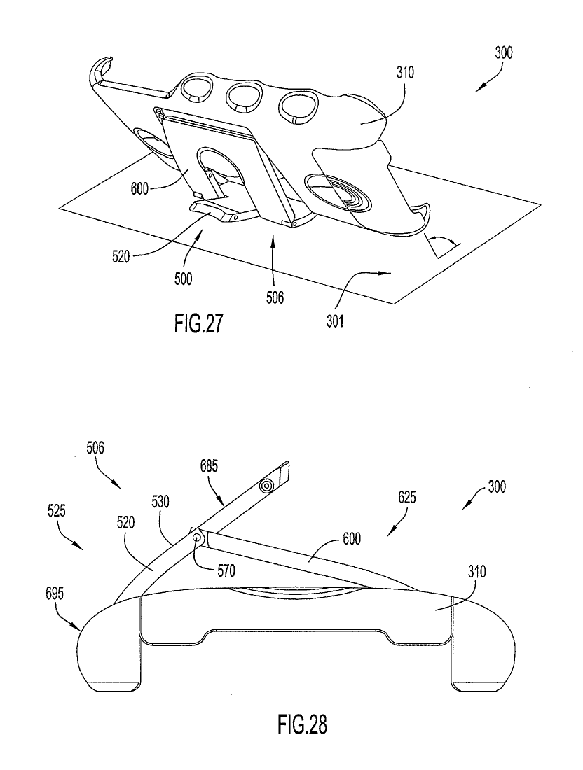

Referring to FIGS. 27-29, the holder 300 is illustrated in a different deployed or use configuration. In this configuration, the support 500 of the holder 300 is placed in an extended configuration 506. Compared to extended configuration 504 illustrated in FIG. 18, the support 500 is positioned so that it extends outwardly less than extended configuration 506 and as a result, the angle between front surface of the electronic device on holder 300 and the support surface 301 is different.

As shown in FIG. 27, each of the support components 520 and 600 has moved relative to the body 310. The support component 520 is shown in an extended position 525 and support component 600 is shown in an extended position 625 (see FIG. 28). When the support 500 is in this extended configuration 506, the contact areas or surfaces 685 and 695 (see FIG. 28) are positioned to engage the support surface 301 at a different angle than in extended configuration 504. Referring to FIG. 29, the support component 520 is moved from its retracted position 521 around axis 580 defined by pin 690 along the direction of arrow “L” to its extended position 525.

Referring to FIG. 29, a cross-sectional view of the holder 300 with its support 500 in its extended configuration 506 shown in FIG. 27 is illustrated. The pin 680 moves along the slot 470 along the direction of arrow “M” when the support component 520 moves along the direction of arrow “L.” To collapse the support 500, support component 520 is moved along the direction of arrow “N” about pin 690 and pin 680 moves along slot 470 along the direction of arrow “O.” Axis 694 in FIG. 29 is the axis about which support components 520 and 600 move relative to each other.

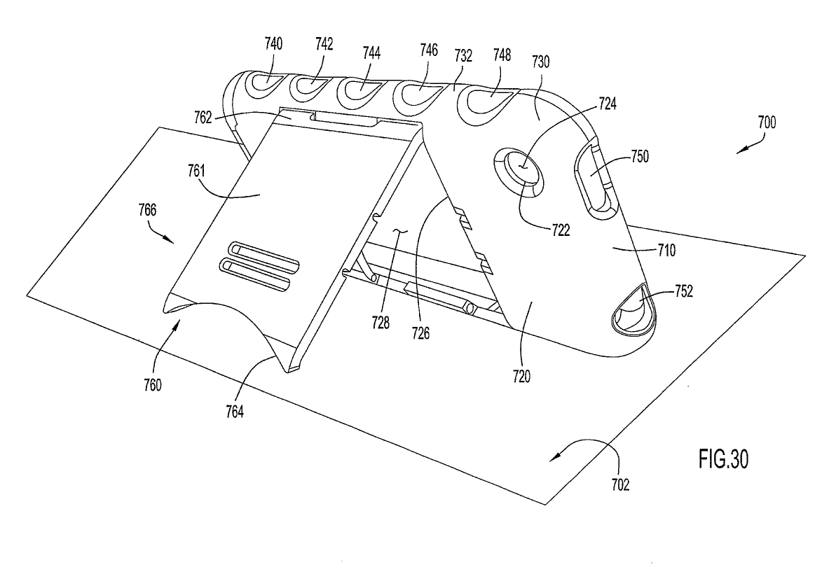

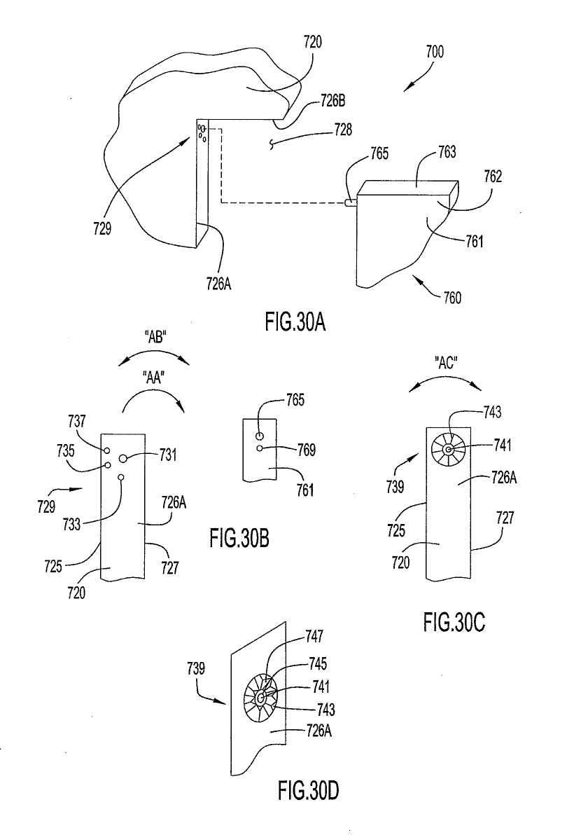

Referring to FIG. 30, an alternative embodiment of a holder is illustrated. In this embodiment, the holder 700 includes a body 710 that includes a base plate or back plate 720 with an edge 722 defining an opening 724. The opening 724 can be positioned so that when an electronic device is coupled to the holder 700, the camera eye of the electronic device is aligned with the opening 724. The plate 720 also includes an edge 726 that defines an opening 728.

In this embodiment, the body 710 includes a coupling mechanism 730 that includes a wall 732 that extends around a portion of an electronic device. The wall 732 includes several openings 740, 742, 744, 746, and 748 that facilitate the gripping of the holder 700 by a user. In addition, the wall 732 includes several other openings (such as openings 750 and 752) that allow access to ports on the electronic device.

The holder 700 includes a support or support portion 760 that is used to support the body 710 relative to a support surface 702. The support portion 760 includes a support component 761 with a mounted end 762 and a distal or free end 764. The mounted end 762 is coupled to the body 710 to pivotally mount the support component 761 to the body 710. The support portion 760 is illustrated in a deployed configuration 766 in FIG. 30. When the support component 761 is moved to its retracted position, the support component 761 is disposed within the body 710 and in particular, within the opening 728.

Referring to FIGS. 30A and 30B, some components of an alternative embodiment of the holder 700 illustrated in FIG. 30 are illustrated. Only a portion of the support 760 is illustrated for ease of reference. The support 760 includes a support component 761 with an end 762 and an end surface 763. In this embodiment, extending from a side wall of the support component 761 is a pin or projection 765 that is formed separately and coupled to the support component 761 by being inserted into a hole or opening on the side of the support component 761. A similar pin or projection (not shown) extends from the opposite side of the support component 761. In an alternative embodiment, the pin 765 may extend through the support component 761 through an opening extending from side-to-side. In another embodiment, each of the pins 765 is integrally molded with the support component 761.

The base plate 720 includes several edge portions that define the opening 728 with only edge portions 726A and 726B illustrated for ease of reference in FIG. 30A. Edge portion 726A includes a positioning mechanism 729 as shown. The positioning mechanism 729 can be used to hold and retain the support component 761 in multiple different extended positions relative to the base plate 720. For example, the support component 761 can be moved a little distance outwardly from the base plate 720 to prop the holder 700 and its associated electronic device at a more upright angle relative to a support surface. Alternatively, the support component 761 can be moved outwardly a farther distance to prop the holder 700 and its associated electronic device at a more reclined angle relative to a support surface.

Referring to FIG. 30B, a close-up view of edge portion 726A of the base plate 720 is illustrated. The base plate 720 includes a front or inner surface 727 and a rear or outer surface 725 between which the opening 728 extends. The edge portion 726A includes an opening 731 formed therein. The opening 731 is configured to receive the pin 765 and to allow the pin 765 to rotate, thereby rotatably supporting the support component 761.

The positioning mechanism 729 includes cooperating components on the base plate 720 and the support component 761 that facilitate the positioning of the support component 761 in several positions relative to the base plate 720. In one embodiment, the support component 761 includes a projection or nub that can engage one of several recesses formed on the base plate 720. In an alternative embodiment, the support component 761 includes a recess that can be engaged by one of several nubs or projections formed on the base plate 720.

Referring to FIG. 30B, the support component 761 includes a nub or projection 769 and the base plate 720 includes several recesses 733, 735, and 737 formed therein. The recesses 733, 735, and 737 are formed to receive the projection 769 and positively retain the projection 769 to hold the support component 761 in a particular extended position relative to the base plate 720. While three recesses 733, 735, and 737 are illustrated, any quantity of recesses may be formed on edge portion 726A.

When the pin 765 is inserted into opening 731, the support component 761 can be rotated about pin 765 along the direction of arrow “AA” to an extended position and along the direction of arrow “AB” to a retracted position. In this embodiment, recess 733 is located so that when nub 769 engages the recess 733, the support component 761 is retained in its retracted position relative to the base plate 720. The engagement of nub 769 with recess 735 maintains the support component 761 in an extended position and the engagement of nub 769 with recess 737 maintains the support component 761 in a greater extended position relative to the base plate 720.

Referring to FIGS. 30C and 30D, an alternative embodiment of a positioning mechanism is illustrated. Only a portion of the edge portion 726A in this embodiment is illustrated for ease of reference. The edge portion 726A of the base plate 720 includes a shoulder 745 that defines an opening 741 that is configured to receive a pin, such as pin 765, on the support component 761. When pin 765 is inserted into opening 741, the support component 761 is rotatably mounted to the base plate 720.

The edge portion 726A also includes a positioning mechanism 739. In this embodiment, the positioning mechanism 739 includes several notches or recesses 743 formed therein that between them form teeth 747. The notches 743 and teeth 747 extend around the perimeter of the shoulder 745. Similarly configured notches and teeth are formed on a side wall of the support component 761 and engageable with the notches 743 and teeth 747 on the edge portion 726A. As a result, when the support component 761 is rotated about pin 765 relative to the base plate 720, the teeth and notches on each of the support component 761 and the edge portion 726A engage each other and form a ratcheting mechanism that can be used to retain the support component 761 in a particular position relative to the base plate 720. In an alternative embodiment, the sets of notches and teeth do not extend all of the way around the shoulder 745.

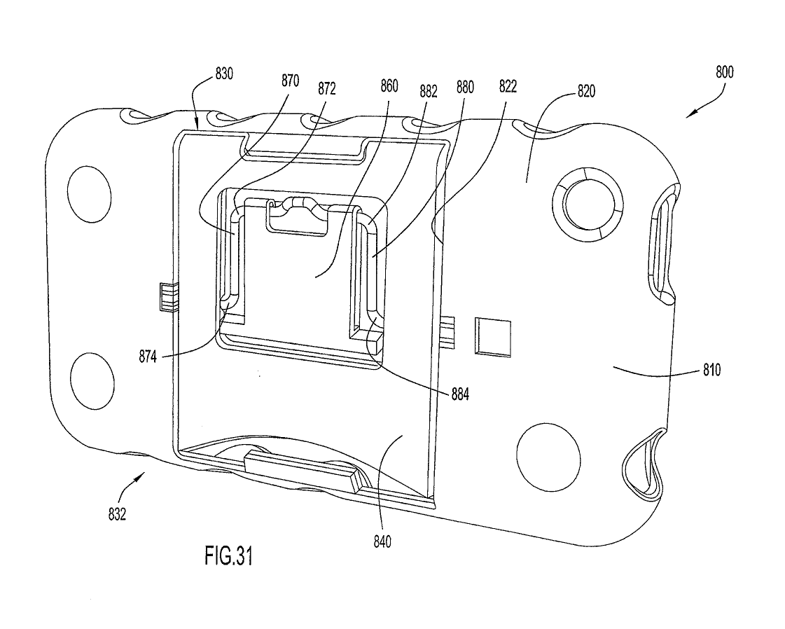

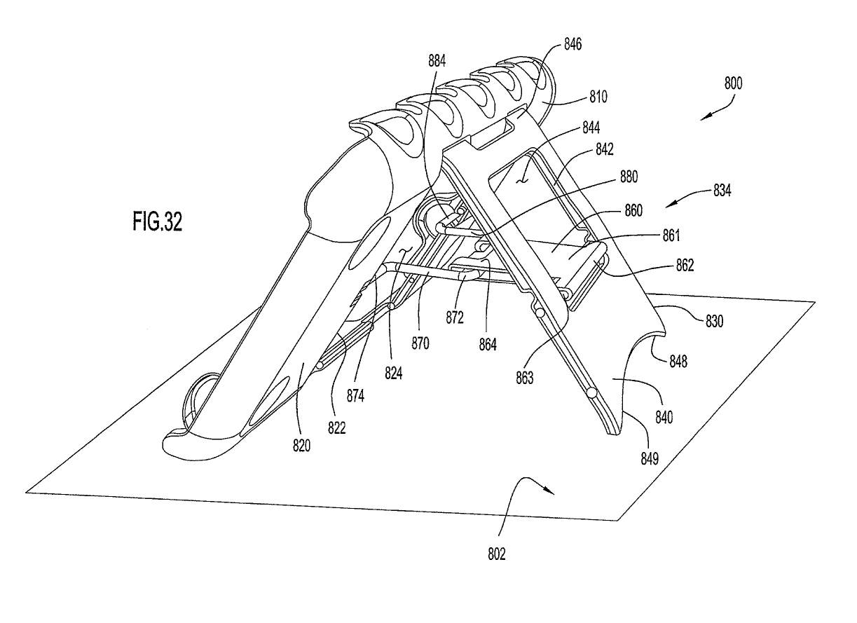

Referring to FIGS. 31 and 32, an alternative embodiment of a holder is illustrated. In this embodiment, the holder 800 includes a body 810 that has a back plate 820 with an edge 822 that defines an opening 824 (see FIG. 32). The holder 810 includes a support or support portion 830 that can be placed in a retracted or collapsed configuration 832 and in an extended or deployed configuration 834. The support 830 can be used to support the holder 800 relative to a support surface 802.

In this embodiment, the support 830 includes a support component 840 and a linking component 860. The linking component can also be referred to as a support component. The support component 840 includes an edge 842 that defines an opening 844 that extends through the support component 840. The support component 840 includes a mounting end 846 that is coupled to the body 810 by a pin (not shown) and an opposite contact end 848 that is configured to engage a support surface 802. The contact end 848 includes a recessed portion 849 that has a curved configuration.

The linking component 860 includes a body 861 that has an end 862 that is pivotally coupled to the support component 840 by a pin 863. The other end 864 of the linking component 860 includes two arms 870 and 880 coupled thereto. Arm 870 includes an end 872 that is pivotally coupled to the body 861 and an opposite end 874 that is pivotally coupled to the body 810 of the holder 810. Similarly, arm 880 includes ends 882 and 884. End 882 is coupled at one end to the body 861 and at its other end 884 to body 810 of the holder 800. The ends 874 and 884 of the arms 870 and 880 are pivotally coupled to the body 810 and the arms 870 and 880 pivot about their respective ends. When the linking component 860 is disposed in its substantially horizontal position illustrated in FIG. 32, the arms 870 and 880 are secured in place by grooves on the body 861 and the linking component 860 maintains the support component 840 in a particular position relative to the remainder of the body 810.

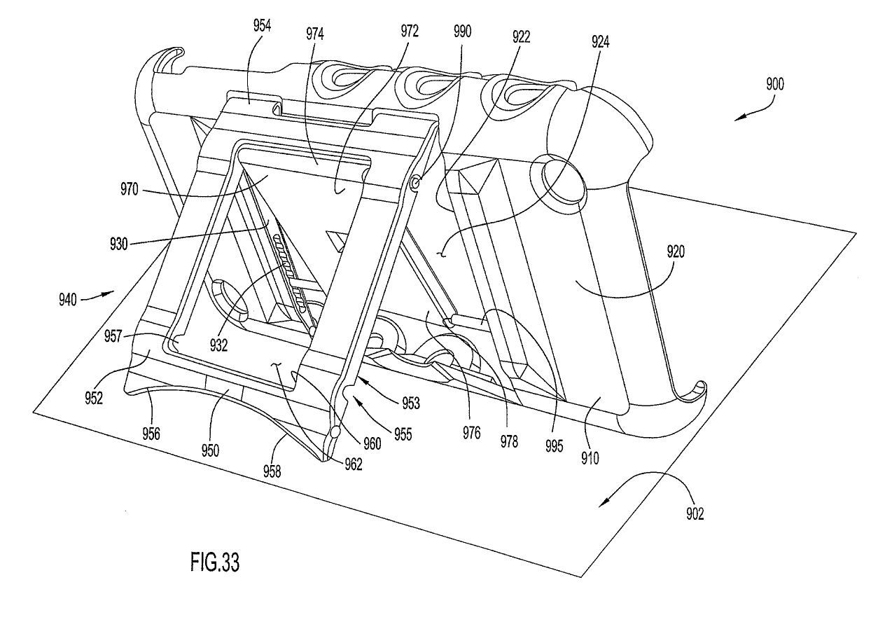

Referring to FIG. 33, an alternative embodiment of a holder is illustrated. In this embodiment, the holder 900 includes a body 910 with a plate 920 that has an edge 922 that defines an opening 924. The edge 922 includes a side wall 930 that has a slot 932 formed therein with projections. A corresponding slot (not shown) is formed in the side wall (not shown) that is opposite to side wall 930.

The holder 900 has a support 940 that can be used to support the holder 900 relative to a support surface 902. The support 940 includes a support component 950 that has a body 952 with opposite ends 954 and 956. End 954 is pivotally coupled to the body 910 by a pin (not shown). End 956 is configured to engage a support surface 902 and may include a curved or recessed portion 958. The body 952 includes an edge 960 that defines an opening 962 within the body 952. In different embodiments, the size and configuration of the opening 962 can vary.

The support 940 includes an additional support component 970 that has a body 972 with opposite ends 974 and 976. End 974 is pivotally coupled to the body 952 of support component 950 by a pin 990 that is inserted through openings formed in the support components 950 and 970. End 976 is coupled to the body 910 of the holder 900 by a pin 995 that extends through opening 978 of the support component 970 and into slot 932 in side wall 930 and the corresponding slot in the side wall opposite to side wall 930. The pin 995 can slide along the slots in the side walls and is retained in particular positions in the slots based on friction and the engagement of the pin 995 with the projections in the slots.

Referring to FIG. 33, in this embodiment, the body 952 of the support member 950 has an inner surface 953 that includes slots or grooves 955 and 957 formed therein. The grooves 955 and 957 are configured to receive the exposed portions of the pin 995 on opposite sides of the support component 970 when the support components 950 and 970 are moved to their retracted positions. As a result, support component 950 can be moved to a retracted position within the body 910 of the case 900.

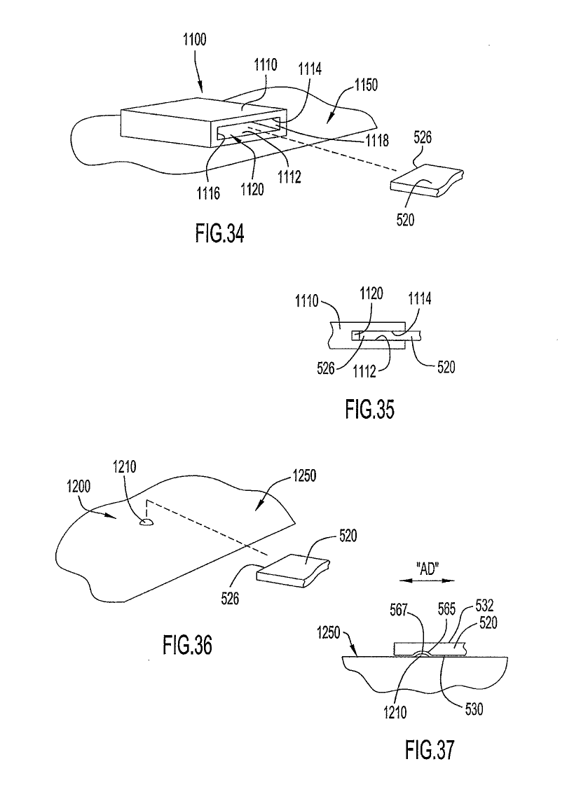

Referring to FIGS. 34-35, an embodiment of an attachment mechanism that can be used to couple a support to a surface, such as a surface of a vehicle such as an automobile, a bicycle, etc. The attachment mechanism 1100 is coupled to a surface 1150. In one embodiment, the surface 1150 is a surface of a vehicle, such as a dashboard for the vehicle. The attachment mechanism 1110 can integrally formed with the surface 1150. Alternatively, the attachment mechanism 1110 can be formed separately from the surface 1150 and coupled to the surface 1150 using any conventional technique or component, such as an adhesive, friction fit, or a fastener or coupler.

The attachment mechanism 1100 includes a body 1110 with several inner walls 1112, 1114, 1116, and 1118 that collectively define a receptacle 1120. The receptacle 1120 can have any shape or configuration in various embodiments. The body 1110 can be formed of molded plastic or similar material.

As shown in FIG. 35, the distal end 526 of support component 520 can be inserted into the receptacle 1120. The distal end 526 can be retained in the receptacle 1120 via friction. In an alternative embodiment, the distal end 526 can be retained in the receptacle 1120 via a locking mechanism, such as a cooperating set of a projection and a recess on opposite surfaces. When the support component 520 is inserted into the receptacle 1120, the holder 300 with support component 520 is held in place and supported relative to support surface 1150. If the frictional contact between the attachment mechanism 1100 and the support component 520 is sufficient, the attachment mechanism 1100 can be oriented at any angle and will still be able to hold and support the support component 520 and its associated holder. Accordingly, a user can view and use the electronic device held by holder 300 and supported relative to surface 1150.

The surface 1150 can be any surface relative to which a user would like to use the electronic device. In one embodiment, the surface 1150 can be a top or front of the dashboard surface in an automobile. In another embodiment, the surface 1150 can be a surface of a bicycle, motorcycle, stroller for infants, computer monitor, desk, table, article of furniture, briefcase or smaller piece of luggage. The attachment mechanism 1110 can be molded plastic, formed metal or any other similar material.

Referring to FIGS. 36 and 37, another embodiment of an attachment mechanism is illustrated. In this embodiment, a surface relative to which the electronic device can be used is illustrated as surface 1250. Similar to surface 1150, surface 1250 can be any type of surface. The surface 1250 includes an attachment mechanism 1200. In one embodiment, the attachment mechanism 1200 includes a nub or protrusion 1210 that is integrally formed with the surface 1250 and extends outwardly from the surface 1250. In an alternative embodiment, the hub or protrusion 1210 is separately formed and subsequently coupled to the surface 1250 using any conventional technique, such as an adhesive. The nub 1210 can be molded plastic or any other similar material.

Referring to FIG. 37, the arrangement of the support component 520 relative to the surface 1250 is illustrated. In this embodiment, the support component 520 has an outer surface 530 and an inner surface 532. The outer surface 530 includes a recess 567 that is defined by a surface 565. The recess 567 is sized to receive the nub 1210 and eliminate movement of the support component 520 along the directions of arrows “AD.” The engagement of the hub 1210 with the recess 567 maintains the support component 520 and its associated holder in a fixed position relative to the surface 1250. Accordingly, a user can view and use the electronic device held by holder 300 and supported relative to surface 1250.

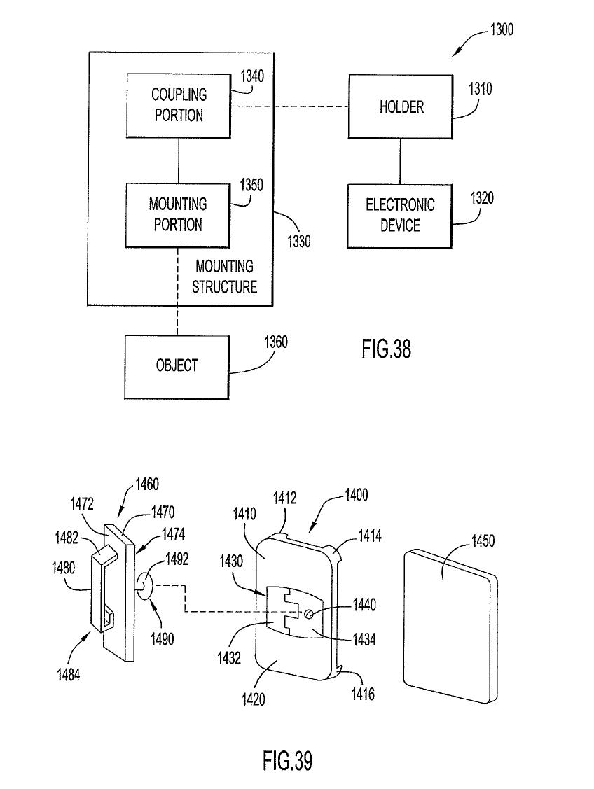

Referring to FIG. 38, a schematic diagram of an embodiment of a system is illustrated. In this embodiment, the system 1300 includes a holder 1310 to which an electronic device 1320 can be coupled. The holder 1310 includes a support (not shown) that can be repositioned relative to the holder 1310 to support the holder 1310 and the electronic device 1320 at various angles relative to a support surface.

A mounting structure 1330 can be used with the holder 1310 to mount the holder 1310 to an object 1360. For example, a user may want to mount the holder 1310 to an object 1360 proximate to the user, such as an article of clothing or an accessory such as a belt. The mounting structure 1330 includes a coupling portion 1340 that couples the holder 1310 to the mounting structure 1330 and a mounting portion 1350 that mounts the mounting structure 1330 to the object 1360. While one embodiment of a mounting structure is illustrated in FIG. 39, in different embodiments, the mounting structure may have different configurations and features.

Referring to FIG. 39, the holder 1400 includes a body 1410 to which an electronic device 1450 can be coupled using coupling members 1412, 1414, and 1416. The holder 1400 includes a repositionable or reconfigurable support 1430 that can be used to support the holder 1400 relative to a support surface. The support 1430 is movable relative to the base plate 1420 and includes support component 1432 and support component 1434 that are coupled together and movable relative to each other. In this embodiment, one of the support components 1432 and 1434 includes an opening 1440 formed therein. The opening 1440 can extend through the particular support component, which in the embodiment illustrated in FIG. 39, is support component 1434.

Also illustrated is an embodiment of a mounting structure 1460 that can be used to mount the holder 1400 to an object such as a belt, article of clothing, or other structure. The mounting structure 1460 includes a body 1470 with opposite surfaces or sides 1472 and 1474. Coupled to side 1472 is a mounting portion or clip 1480 that is configured to be used to mount the body 1470 to the object. The mounting portion 1480 has a coupled end 1482 and a free end 1484. In this embodiment, the mounting portion 1480 is a resilient arm that is coupled to the body 1470. The resilient arm may be made of plastic or molded rubber. The free end 1484 can be moved relative to surface 1472 so that the object, such as a belt, can be inserted between the mounting portion 1480 and the body 1470. In an alternative embodiment, the mounting portion 1480 can be a pivotally mounted arm that is biased into a closed position via a biasing member, such as a spring. The free end of the pivotally mounted arm can be moved away from the body 1470 to accommodate the object and released to mount the mounting structure 1460 to the object. The free of the mounting portion 1480 can be moved away from the body 1470 again so that the object can be removed.

The mounting structure 1460 also includes a coupling portion 1490 that is located proximate to surface 1474 of the body 1470. The coupling portion 1490 includes a projection or protrusion 1492 that can be inserted or snapped into opening 1440 of support 1430 to couple the holder 1400 to the mounting structure 1460. In other embodiments, the positions of the projection 1492 and the opening 1440 can be reversed. In one embodiment, the configuration of the coupling portion 1490 can vary provided that a positive engagement between the coupling portion 1490 and the holder 1400 is achieved. The coupling portion 1490 is configured to allow for the adjustment of the holder 1400 and the electronic device 1450 coupled thereto by the user, such as by spinning the holder 1400 to a desired orientation or position.

In one embodiment, the portions or components of the mounting structure 1460 can be integrally formed. In other embodiments, the portions or components of the mounting structure 1460 can be formed separately and subsequently coupled to each other.

In alternative embodiments, a holder may include multiple supports or support portions. In other embodiments, the configuration of the coupling mechanism of the holder, which couples the holder to an electronic device, can vary.

Thus, it is intended that the present invention cover the modifications and variations of this invention. For example, it is to be understood that terms such as “left,” “right,” “top,” “bottom,” “front,” “rear,” “side,” “height,” “length,” “width,” “upper,” “lower,” “interior,” “exterior,” “inner,” “outer,” and the like as may be used herein, merely describe points of reference and do not limit the present invention to any particular orientation or configuration. Further, terms such as “first,” “second,” “third,” etc., merely identify one of a number of portions, components and/or points of reference as disclosed herein, and likewise do not limit the present invention to any particular configuration or orientation.

While the invention has been described in detail and with references to specific embodiments thereof, it will be apparent to one skilled in the art that various changes and modifications can be made therein without departing from the spirit and scope thereof. Thus, it is intended that the present invention covers the modifications and variations of this invention.

What is claimed is:

1. A holder for a portable device, comprising:
a body including a first coupling member and a second coupling member, each of the coupling members extending from the body, the coupling members being configured to couple a portable device to the body; and
a support movably coupled to the body, the support being movable between a retracted position and at least two extended positions relative to the body, the at least two extended positions including a first extended position and a second extended position, the second extended position being different from the first extended position, the support being disposed within the body in its retracted position, the support extending from the body in its extended positions, the support being engageable with a support surface to support the body in at least two desired angles relative to the support surface.

2. The holder of claim 1, wherein the body has an inner surface, an outer surface, and an opening extending from the inner surface to the outer surface, the support being disposed in the opening when the support is in its retracted position.

3. The holder of claim 2, wherein the body has a thickness defined by the distance between the inner surface and the outer surface and the support has a thickness substantially the same as the thickness of the body when the support is in its retracted position.

4. The holder of claim 1, wherein the body includes a positioning mechanism, the positioning mechanism defining a plurality of positions greater than three in which the support may be retained.

5. The holder of claim 4, wherein the positioning mechanism includes at least one slot and the support includes at least one pin, the at least one pin being slidably engaged with the at least one slot.

6. The holder of claim 1, wherein the body includes a plurality of corners and each of the first and second coupling members is located proximate to one of the corners.

7. The holder of claim 6, wherein the body includes a third coupling member and a fourth coupling member, each of the third coupling member and the fourth coupling member being located proximate to one of the corners of the body.

8. The holder of claim 1, wherein the body includes a sound reflector slidably coupled thereto, the sound reflector being movable between a retracted position and a reflecting position.

9. A holder for a portable device, comprising:
a body including a first coupling member and a second coupling member, each of the coupling members extending from the body, the coupling members being configured to couple a portable device to the body; and
a support movably coupled to the body, with a thickness substantially the same as the thickness of the body, the support being movable between a retracted position and at least two extended positions relative to the body, the support being disposed within the body in its retracted position, the support extending from the body in its extended positions, the support being engageable with a support surface to support the body in at least two desired angles relative to the support surface.

10. The holder of claim 9, wherein the body includes a positioning mechanism, the positioning mechanism defining a plurality of positions greater than three in which the support may be retained.

11. The holder of claim 10, wherein the positioning mechanism includes at least one slot and the support includes at least one pin, the at least one pin being slidably engaged with the at least one slot.

12. The holder of claim 9, wherein the body includes a plurality of corners and each of the first and second coupling members is located proximate to one of the corners.

13. The holder of claim 12, wherein the body includes a third coupling member and a fourth coupling member, each of the third coupling member and the fourth coupling member being located proximate to one of the corners of the body.

14. The holder of claim 9, wherein the body includes a sound reflector slidably coupled thereto, the sound reflector being movable between a retracted position and a reflecting position.

15. A holder for a portable device, comprising:
a body including a first coupling member and a second coupling member, each of the coupling members extending from the body, the coupling members being configured to couple a portable device to the body; and
a sound reflector coupled thereto, the sound reflector being movable between a retracted position and a reflecting position

16. The holder of claim 15, wherein the sound reflector is made or coated by a material that is more sonically reflective than the material of the body.

17. A holder for a portable device including a front surface, a rear surface and a side wall extending between the front surface and the rear surface, the holder comprising:
a mounting portion configured to be coupled to the portable device with the front surface of the portable device exposed, the mounting portion covering at least part of the rear surface of the portable device and portions of the side wall of the portable device; and
a support portion movably coupled to the mounting portion, the support portion being disposable in a retracted position and in at least two extended positions relative to the mounting portion, substantially all of the support portion being disposed within the body when the support portion is in its retracted position, and substantially all the support portion extending from the body when the support portion is in its extended positions.

18. The holder of claim 17, wherein the support portion is disposed entirely within the mounting portion when the support portion is in its retracted position.

19. The holder of claim 17, wherein the coverage of the side wall by the mounting portion is discontinuous.

20. The holder of claim 17, wherein the support portion includes a first component having a first end and a second end and a second component having a first end and a second end, the first end of the first component is pivotally coupled to the mounting portion, the second end of the first component is pivotally coupled to the second component, and the first end of the first component is slidably coupled to the mounting portion.

21. The holder of claim 20, wherein the first component includes a substantially planar portion configured to engaged a support surface.

22. The holder of claim 20, wherein the orientation of each of the first component and the second component varies when the support portion moves from its retracted position to its extended position.

23. The holder of claim 22, wherein the angle between the first component and the second component varies when the support portion moves from its retracted position to its extended position.

24. A holder for a portable device including a front surface, a rear surface, a side wall extending between the front surface and the rear surface and a plurality of corners, the holder comprising:
a base including a first coupling member and a second coupling member, each of the coupling members extending from the base, the coupling members being configured to extend along the side wall of the portable device, the first coupling member being configured to cover a first corner of the portable device, the second coupling member being configured to cover a second corner of the portable device, each of the coupling members having a length such that the front surface of the portable device is not covered by either of the coupling members when the holder is coupled to the portable device; and
a support movably coupled to the base, the support being movable between a retracted position and at least two extended positions relative to the base, the support being engageable with a support surface to support the base and the portable device at desired angles relative to the support surface.

25. The holder of claim 24, wherein the first corner of the portable device is covered by the first coupling member and the second corner of the portable device is covered by the second coupling member.

26. The holder of claim 24, wherein the portable device includes a third corner and a fourth corner, and the base includes a third coupling member that covers the third corner and a fourth coupling member that covers the fourth corner, each of the third coupling member and the fourth coupling member has a length such that the front surface of the portable device is not covered by either of the third or fourth coupling members when the holder is coupled to the portable device.

27. The holder of claim 24, wherein the support extends from the base in its extended position and is disposed within the base in its retracted position.

28. A method of manufacturing a holder for an electronic device, the holder including a body and a support having a first support component and a second support component coupled to the first support component, the support being movable between a retracted position and at least two extended positions relative to the body, the support being disposed within the body in its retracted position and extending from the body in its extended positions, the first support component including a first connector and the second support component including a second connector, the method comprising the steps of:
forming the body with a first coupling member and a second coupling member, each of the coupling members extending from the body and collectively being configured to couple the body to the electronic device, the body including a notch formed therein and a slot formed therein;
coupling the first support component to the body by engaging the first connector with the slot; and
coupling the second support component to the body by engaging the second connector with the notch.

29. The method of claim 28, wherein the connection between the first connector and the slot is a slidable connection and the connection between the second connector and the notch is a pivotable connection.

30. The method of claim 28, wherein the slot is a first slot and the body includes a second slot opposite to the first slot, the step of coupling the first support component includes engaging the first connector with the second slot.

31. The method of claim 30, wherein the notch is a first notch and the body includes a second notch opposite to the first notch, the step of coupling the second support component includes engaging the second connector with the second notch.

32. The method of claim 31, wherein the first connector has a first end and a second end, the first end of the first connector being inserted into the first slot before the second end of the first connector is inserted into the second slot.

33. A method of adjusting a holder for an electronic device, the holder including a body configured to be coupled to the electronic device, the holder including a support movable between a retracted position and at least two extended positions relative to the body, the support being disposed within the body in its retracted position and extending from the body in its extended positions, the first support component including a first connector coupled to the body and the second support component including a second connector coupled to the body, the method comprising the steps of:
moving the first connector along the body from a retracted position to an extended position, the first support component being disposed in a retracted position when the first connector is in its retracted position and in an extended position when the first connector is in its extended position; and
moving the second support component about the second connector relative to the body from a retracted position to an extended position.

34. The method of claim 33, wherein the step of moving the first connector along the body from a retracted position to an extended position includes sliding the first connector along the body.

35. The method of claim 34, wherein the body includes at least one slot and the step of moving the first connector includes moving the first connector along the at least one slot.

36. The method of claim 33, wherein the second connector is pivotally coupled to the body and the step of moving the second support component includes rotating the second support component about the second connector.

37. The method of claim 33, wherein the extended position is a first extended position, the method further comprising:
moving the first connector along the body from the first extended position to a second extended position different than the first extended position.

38. The method of claim 37, wherein the second support component is rotated about the second connector simultaneously with the movement of the first connector between its retracted position and either of its first extended position and its second extended position.
